(19) United States
(12) Patent Application Publication
(10) Pub. No.: US 2026/0074968 A1
(43) Pub. Date: Mar. 12, 2026

(54) METHOD FOR REPORTING TERMINAL PROCESSING CAPABILITY, DATA PROCESSING METHOD, AND APPARATUSES THEREFOR

(71) Applicant: BEIJING XIAOMI MOBILE SOFTWARE CO., LTD., Beijing (CN)

(72) Inventors: Xuemei QIAO, Beijing (CN); Qin MU, Beijing (CN); Yuanyuan LI, Beijing (CN)

(21) Appl. No.: 19/106,912

(22) PCT Filed: Aug. 31, 2022
(86) PCT No.: PCT/CN2022/116333

§ 371 Date: Feb. 26, 2025

(51) Int. Cl. H04L 41/5009; H04B 7/06; H04L 43/065

(52) U.S. Cl. CPC H04L 41/5012; H04B 7/0626; H04L 43/065

(57) ABSTRACT

A method for reporting a terminal processing capability, a data processing method, and apparatuses are applicable to a new radio (NR) system. The reporting method for reporting a terminal processing capability includes: determining the terminal processing capability supported by the terminal; and sending information indicating the terminal processing capability supported by the terminal to a network device. The terminal is an enhanced reduced capability (eRedCap) terminal; and the terminal processing capability includes at least one of a first processing capability, a second processing capability or a third processing capability, wherein the first processing capability is lower than the second processing capability, and the third processing capability is lower than the first processing capability.

### CROSS-REFERENCE TO RELATED APPLICATION

The present application is a U.S. National Stage of International Application No. PCT/CN2022/116333, filed on Aug. 31, 2022, the contents of all of which are incorporated herein by reference in their entireties for all purposes.

### BACKGROUND

At present, standards established for wireless communications networks support terminals that can report two processing capabilities: user equipment (UE) processing capability 1 and user equipment (UE) processing capability 2, which are related to the processing time of the terminal. Each capability corresponds to a different physical downlink shared channel (PDSCH) processing time (N1) and a different physical uplink shared channel (PUSCH) preparation time (N2) at a different subcarrier spacing. In the study item (SI) of Release 18 (R18) from the Third Generation Partnership Project (3GPP), it is proposed to relax the processing time (i.e. the PDSCH processing time and the PUSCH preparation time) of the terminal, for example, to relax the processing time to n times of a certain processing capability in Release 15 (R15) (where n may be a number greater than 1), so as to reduce the cost of the terminal. The terminal supporting this relaxation of the processing time is called an enhanced reduced capability (eRedCap) terminal.

### SUMMARY

The present disclosure relates to the field of wireless communication technologies, and more particularly to a method for reporting a terminal processing capability, a data processing method and apparatuses therefor.

In a first aspect, an embodiment of the present disclosure provides a method for reporting a terminal processing capability, which is performed by a terminal, and includes:
determining the terminal processing capability supported by the terminal; and
sending information indicating the terminal processing capability supported by the terminal to a network device.

The terminal is an eRedCap terminal; and the terminal processing capability includes at least one of a first processing capability, a second processing capability and a third processing capability. The first processing capability is lower than the second processing capability, and the third processing capability is lower than the first processing capability.

In a second aspect, an embodiment of the present disclosure provides a method for determining a terminal processing capability, which is performed by a network device, and includes:
receiving information indicating the terminal processing capability supported by a terminal sent by the terminal; and
determining the terminal processing capability supported by the terminal according to the information.

The terminal is an eRedCap terminal; and the terminal processing capability includes at least one of a first processing capability, a second processing capability and a third processing capability. The first processing capability is lower than the second processing capability, and the third processing capability is lower than the first processing capability.

In a third aspect, an embodiment of the present disclosure provides a data processing method, which is performed by a terminal, and includes:
sending information indicating a terminal processing capability supported by the terminal to a network device;
receiving configuration information configured by the network device for the terminal according to the terminal processing capability supported by the terminal; and
enabling a corresponding processing capability for data processing according to the information and/or the configuration information.

The terminal is an eRedCap terminal; and the terminal processing capability includes at least one of a first processing capability, a second processing capability and a third processing capability. The first processing capability is lower than the second processing capability, and the third processing capability is lower than the first processing capability.

In a fourth aspect, an embodiment of the present disclosure provides another data processing method, which is performed by a network device, and includes:
receiving information indicating a terminal processing capability supported by a terminal sent by the terminal;
configuring a processing capability of the terminal according to the terminal processing capability supported by the terminal; and
sending configuration information to the terminal, in which the configuration information is configured to instruct the terminal to perform data processing based on the processing capability corresponding to the configuration by the network device.

The terminal is an eRedCap terminal; and the terminal processing capability includes at least one of a first processing capability, a second processing capability and a third processing capability. The first processing capability is lower than the second processing capability, and the third processing capability is lower than the first processing capability.

In a fifth aspect, an embodiment of the present disclosure provides a communication apparatus, which has part or all of functions of the terminal in the method described in the first aspect. For example, the function of the communication apparatus may include the functions of part or all of the embodiments in the present disclosure, or may include the function of separately implementing any one of the embodiments in the present disclosure. The functions may be realized by hardware, or by hardware executing corresponding software. The hardware or software includes one or more units or modules corresponding to the above functions.

In an implementation, the structure of the communication apparatus may include a transceiving module and a processing module, and the processing module is configured to support the communication apparatus to perform the corresponding functions in the above method. The transceiving module is configured to support communication between the communication apparatus and other devices. The communication apparatus may further include a storage module for coupling with the transceiving module and the processing module, and storing necessary computer programs and data of the communication apparatus.

As an example, the processing module may be a processor, the transceiving module may be a transceiver or a communication interface, and the storage module may be a memory.

In a sixth aspect, an embodiment of the present disclosure provides another communication apparatus, which has part or all of functions of the network device in the method described in the second aspect. For example, the function of the communication apparatus may include the functions of part or all of the embodiments of the present disclosure, or may include the function of separately implementing any one of the embodiments of the present disclosure. The functions may be realized by hardware, or by hardware executing corresponding software. The hardware or software includes one or more units or modules corresponding to the above functions.

In an implementation, the structure of the communication apparatus may include a transceiving module and a processing module, and the processing module is configured to support the communication apparatus to perform the corresponding functions in the above method. The transceiving module is configured to support communication between the communication apparatus and other devices. The communication apparatus may further include a storage module for coupling with the transceiving module and the processing module, and storing necessary computer programs and data of the communication apparatus.

As an example, the processing module may be a processor, the transceiving module may be a transceiver or a communication interface, and the storage module may be a memory.

In a seventh aspect, an embodiment of the present disclosure provides another communication apparatus, which has part or all of functions of the terminal in the method described in the third aspect. For example, the function of the communication apparatus may include the functions of part or all of the embodiments in the present disclosure, or may include the function of separately implementing any one of the embodiments in the present disclosure. The functions may be realized by hardware, or by hardware executing corresponding software. The hardware or software includes one or more units or modules corresponding to the above functions.

In an implementation, the structure of the communication apparatus may include a transceiving module and a processing module, and the processing module is configured to support the communication apparatus to perform the corresponding functions in the above method. The transceiving module is configured to support communication between the communication apparatus and other devices. The communication apparatus may further include a storage module for coupling with the transceiving module and the processing module, and storing necessary computer programs and data of the communication apparatus.

As an example, the processing module may be a processor, the transceiving module may be a transceiver or a communication interface, and the storage module may be a memory.

In an eighth aspect, an embodiment of the present disclosure provides another communication apparatus, which has part or all of functions of the network device in the method described in the fourth aspect. For example, the function of the communication apparatus may include the functions of part or all of the embodiments in the present disclosure, or may include the function of separately implementing any one of the embodiments in the present disclosure. The functions may be realized by hardware, or by hardware executing corresponding software. The hardware or software includes one or more units or modules corresponding to the above functions.

In an implementation, the structure of the communication apparatus may include a transceiving module and a processing module, and the processing module is configured to support the communication apparatus to perform the corresponding functions in the above method. The transceiving module is configured to support communication between the communication apparatus and other device. The communication apparatus may further include a storage module for coupling with the transceiving module and the processing module, and storing necessary computer programs and data of the communication apparatus.

As an example, the processing module may be a processor, the transceiving module may be a transceiver or a communication interface, and the storage module may be a memory.

In a ninth aspect, an embodiment of the present disclosure provides a communication apparatus, which includes a processor, and when the processor calls a computer program in a memory, the method described in the first aspect is executed.

In a tenth aspect, an embodiment of the present disclosure provides a communication apparatus, which includes a processor, and when the processor calls a computer program in a memory, the method described in the second aspect is executed.

In an eleventh aspect, an embodiment of the present disclosure provides a communication apparatus, which includes a processor, and when the processor calls a computer program in a memory, the method described in the third aspect is executed.

In a twelfth aspect, an embodiment of the present disclosure provides a communication apparatus, which includes a processor, and when the processor calls a computer program in a memory, the method described in the fourth aspect is executed.

In a thirteenth aspect, an embodiment of the present disclosure provides a communication apparatus, which includes a processor and a memory, and a computer program is stored in the memory; and the processor executes the computer program stored in the memory, so that the communication apparatus performs the method described in the first aspect.

In a fourteenth aspect, an embodiment of the present disclosure provides a communication apparatus, which includes a processor and a memory, and a computer program is stored in the memory; and the processor executes the computer program stored in the memory, so that the communication apparatus performs the method described in the second aspect.

In a fifteenth aspect, an embodiment of the present disclosure provides a communication apparatus, which includes a processor and a memory, and a computer program is stored in the memory; and the processor executes the computer program stored in the memory, so that the communication apparatus performs the method described in the third aspect.

In a sixteenth aspect, an embodiment of the present disclosure provides a communication apparatus, which includes a processor and a memory, and a computer program is stored in the memory; and the processor executes the computer program stored in the memory, so that the communication apparatus performs the method described in the fourth aspect.

In a seventeenth aspect, an embodiment of the present disclosure provides a communication apparatus, which includes a processor and an interface circuit, the interface circuit is configured to receive code instructions and transmit them to the processor, and the processor is configured to run the code instructions to cause the apparatus to perform the method described in the first aspect.

In an eighteenth aspect, an embodiment of the present disclosure provides a communication apparatus, which includes a processor and an interface circuit, the interface circuit is configured to receive code instructions and transmit them to the processor, and the processor is configured to run the code instructions to cause the apparatus to perform the method described in the second aspect.

In a nineteenth aspect, an embodiment of the present disclosure provides a communication apparatus, which includes a processor and an interface circuit, the interface circuit is configured to receive code instructions and transmit them to the processor, and the processor is configured to run the code instructions to cause the apparatus to perform the method described in the third aspect.

In a twentieth aspect, an embodiment of the present disclosure provides a communication apparatus, which includes a processor and an interface circuit, the interface circuit is configured to receive code instructions and transmit them to the processor, and the processor is configured to run the code instructions to cause the apparatus to perform the method described in the fourth aspect.

In a twenty-first aspect, an embodiment of the present disclosure provides a communication system, which includes the communication apparatus described in the fifth aspect and the communication apparatus described in the sixth aspect, or includes the communication apparatus described in the seventh aspect and the communication apparatus described in the eighth aspect, or includes the communication apparatus described in the ninth aspect and the communication apparatus described in the tenth aspect, or includes the communication apparatus described in the eleventh aspect and the communication apparatus described in the twelfth aspect, or includes the communication apparatus described in the thirteenth aspect and the communication apparatus described in the fourteenth aspect, or includes the communication apparatus described in the fifteenth aspect and the communication apparatus described in the sixteenth aspect, or includes the communication apparatus described in the seventeenth aspect and the communication apparatus described in the eighteenth aspect, or includes the communication apparatus described in the nineteenth aspect and the communication apparatus described in the twentieth aspect.

In a twenty-second aspect, an embodiment of the present disclosure provides a computer-readable storage medium for storing instructions for the terminal, which, when executed, causes the terminal to perform the method described in the first aspect.

In a twenty-third aspect, an embodiment of the present disclosure provides a readable storage medium for storing instructions for the network device, which, when executed, causes the network device to perform the method described in the second aspect.

In a twenty-fourth aspect, an embodiment of the present disclosure provides a readable storage medium for storing instructions for the terminal, which, when executed, causes the terminal to perform the method described in the third aspect.

In a twenty-fifth aspect, an embodiment of the present disclosure provides a readable storage medium for storing instructions for the network device, which, when executed, causes the network device to perform the method described in the fourth aspect.

In a twenty-sixth aspect, the present disclosure also provides a computer program product including a computer program, which, when run on a computer, causes the computer to perform the method described in the first aspect.

In a twenty-seventh aspect, the present disclosure also provides a computer program product including a computer program, which, when run on a computer, causes the computer to perform the method described in the second aspect.

In a twenty-eighth aspect, the present disclosure also provides a computer program product including a computer program, which, when run on a computer, causes the computer to perform the method described in the third aspect.

In a twenty-ninth aspect, the present disclosure also provides a computer program product including a computer program, which, when run on a computer, causes the computer to perform the method described in the fourth aspect.

In a thirtieth aspect, the present disclosure provides a computer program which, when run on a computer, causes the computer to perform the method described in any one of the above embodiments.

### BRIEF DESCRIPTION OF THE DRAWINGS

In order to more clearly explain the technical scheme in embodiments of the present disclosure or the related art, the drawings needed in the embodiments of the present disclosure or the related art will be explained below.

FIG. 1 is a schematic architecture diagram of a communication system provided by an embodiment of the present disclosure.

FIG. 2 is a flow chart of a method for reporting a terminal processing capability performed by a terminal as provided by an embodiment of the present disclosure.

FIG. 3 is a flow chart of another method for reporting a terminal processing capability provided by an embodiment of the present disclosure.

FIG. 4 is a flow chart of another method for reporting a terminal processing capability provided by an embodiment of the present disclosure.

FIG. 5 is a flow chart of another method for reporting a terminal processing capability provided by an embodiment of the present disclosure.

FIG. 6 is a flow chart of another method for reporting a terminal processing capability provided by an embodiment of the present disclosure.

FIG. 7 is a flow chart of another method for reporting a terminal processing capability provided by an embodiment of the present disclosure.

FIG. 8 is a flow chart of another method for reporting a terminal processing capability provided by an embodiment of the present disclosure.

FIG. 9 is a flow chart of another method for reporting a terminal processing capability provided by an embodiment of the present disclosure.

FIG. 10 is a flow chart of another method for reporting a terminal processing capability provided by an embodiment of the present disclosure.

FIG. 11 is a flow chart of another method for reporting a terminal processing capability provided by an embodiment of the present disclosure.

FIG. 12 is a flow chart of a method for determining a terminal processing capability performed by a network device as provided by an embodiment of the present disclosure.

FIG. 13 is a flow chart of another method for determining a terminal processing capability provided by an embodiment of the present disclosure.

FIG. 14 is a flow chart of another method for determining a terminal processing capability provided by an embodiment of the present disclosure.

FIG. 15 is a flow chart of another method for determining a terminal processing capability provided by an embodiment of the present disclosure.

FIG. 16 is a flow chart of another method for determining a terminal processing capability provided by an embodiment of the present disclosure.

FIG. 17 is a flow chart of another method for determining a terminal processing capability provided by an embodiment of the present disclosure.

FIG. 18 is a flow chart of another method for determining a terminal processing capability provided by an embodiment of the present disclosure.

FIG. 19 is a flow chart of another method for determining a terminal processing capability provided by an embodiment of the present disclosure.

FIG. 20 is a flow chart of another method for determining a terminal processing capability provided by an embodiment of the present disclosure.

FIG. 21 is a flow chart of another method for determining a terminal processing capability provided by an embodiment of the present disclosure.

FIG. 22 is a flow chart of a data processing method performed by a terminal as provided by an embodiment of the present disclosure.

FIG. 23 is a flow chart of a data processing method performed by a network device as provided by an embodiment of the present disclosure.

FIG. 24 is a schematic diagram of a communication apparatus provided by an embodiment of the present disclosure.

FIG. 25 is a schematic diagram of another communication apparatus provided by an embodiment of the present disclosure.

### DETAILED DESCRIPTION

Hereinafter, embodiments of the present disclosure will be described in detail, examples of which are illustrated in the accompanying drawings, in which the same or similar reference numerals indicate the same or similar elements or elements having the same or similar functions throughout the specification. The embodiments described below by referring to the accompanying drawings are illustrative and are intended to explain the present disclosure, and should not be construed as limiting the present disclosure. In the description of the present disclosure, unless otherwise specified, “/” means or, for example, A/B may mean A or B. In this specification, “and/or” is only a kind of relationship that describes associated objects, which means that there may be three kinds of relationships, for example, A and/or B may mean that A exists alone, both A and B exist, and B exists alone.

At present, the standard supports a terminal to report two processing capabilities: user equipment (UE) processing capability 1 and user equipment (UE) processing capability 2, which are related to a processing time of the terminal. Each capability corresponds to a different physical downlink shared channel (PDSCH) processing time (N1) and a different physical uplink shared channel (PUSCH) preparation time (N2) at a different subcarrier spacing.

Regarding the PDSCH processing time of the terminal (e.g., the UE):

The new radio (NR) supports two kinds of UE capabilities with different PDSCH processing times (N1), namely PDSCH processing capability 1 and PDSCH processing capability 2, which correspond to UE processing capability 1 and UE processing capability 2, respectively. There is a corresponding relationship between a subcarrier spacing of the PDSCH and the PDSCH processing time (N1) at a different processing capability. For example, Table 1 below shows the corresponding relationship between the subcarrier spacing of the PDSCH and the PDSCH processing time (N1) at PDSCH processing capability 1.

TABLE 1
PDSCH processing time for PDSCH Processing Capability 1

| | PDSCH decoding time N₁ [symbols] | |
|---|---|---|
| | dmrs-AdditionalPosition = ‘pos0’ | dmrs-AdditionalPosition ≠ ‘pos0’ |
| | in DMRS-DownlinkConfig in | in DMRS-DownlinkConfig in any of |
| | dmrs-DownlinkForPDSCH- | dmrs-DownlinkForPDSCH- |
| | MappingTypeA and dmrs- | MappingTypeA, dmrs- |
| | DownlinkForPDSCH-MappingTypeB if | DownlinkForPDSCH-MappingTypeB, |
| | either higher layer parameter is configured, | dmrs-DownlinkForPDSCH- |
| | and in dmrs-DownlinkForPDSCH- | MappingTypeA-DCI-1-2, dmrs- |
| | MappingTypeA-DCI-1-2 and dmrs- | DownlinkForPDSCH-MappingTypeB- |
| | DownlinkForPDSCH-MappingTypeB- | DCI-1-2, |
| | DCI-1-2 if either higher layer parameter is | or if none of the higher layer |
| μ | configured | parameters is configured |
| 0 | 8 | N_{1, 0} |
| 1 | 10 | 13 |
| 2 | 17 | 20 |
| 3 | 20 | 24 |
| 5 | 80 | 96 |
| 6 | 160 | 192 |

μ represents a size of the subcarrier spacing of the PDSCH. As shown in Table 1, under PDSCH processing capability 1, when μ=0, the corresponding PDSCH processing time (N1) is 8; when μ=1, the corresponding PDSCH processing time (N₁) is 10; when μ=2, the corresponding PDSCH processing time (N₁) is 17, and so on. When μ=6, the corresponding PDSCH processing time (N₁) is 160.

For example, Table 2 below shows the corresponding relationship between the subcarrier spacing of the PDSCH and the PDSCH processing time (N₁) at PDSCH processing capability 2.

TABLE 2
PDSCH processing time for PDSCH Processing Capability 2

| | PDSCH decoding time N₁ [symbols] |
|---|---|
| | dmrs-AdditionalPosition = ‘pos0’ in DMRS-DownlinkConfig in |
| | dmrs-DownlinkForPDSCH-MappingTypeA and dmrs-DownlinkForPDSCH- |
| | MappingTypeB if either higher layer parameter is configured, and in dmrs- |
| | DownlinkForPDSCH-MappingTypeA-DCI-1-2 and dmrs-DownlinkForPDSCH- |
| μ | MappingTypeB-DCI-1-2 if either higher layer parameter is configured |
| 0 | 3 |
| 1 | 4.5 |
| 2 | 9 for frequency range 1 |

As shown in Table 2, at PDSCH processing capability 2, when μ=0, the corresponding PDSCH processing time (N₁) is 3; When μ=1, the corresponding PDSCH processing time (N₁) is 4.5; When μ=2, the corresponding PDSCH processing time (N₁) is 9, which is used for frequency range 1.

It may be seen from Table 1 and Table 2 that at the same subcarrier spacing, the PDSCH processing time for PDSCH processing capability 2 is smaller than the PDSCH processing time for PDSCH processing capability 1, that is, the PDSCH processing time of the UE with PDSCH processing capability 2 is shorter.

Regarding the PUSCH preparation time of the terminal (e.g., the UE):

The NR supports two kinds of UE capabilities with different PUSCH preparation times (N₂), namely PUSCH timing capability 1 and PUSCH timing capability 2, which correspond to UE processing capability 1 and UE processing capability 2, respectively. For example, Table 3 below shows the corresponding relationship between the subcarrier spacing of the PUSCH and the PUSCH preparation time (N₂) at PUSCH timing capability 1.

TABLE 3
PUSCH preparation time for PUSCH timing capability 1

| μ | PUSCH preparation time N₂ [symbols] |
|---|---|
| 0 | 10 |
| 1 | 12 |
| 2 | 23 |
| 3 | 36 |
| 5 | 144 |
| 6 | 288 |

In Table 3, u represents a size of the subcarrier spacing of the PUSCH. As shown in Table 3, at PUSCH timing capability 1, when μ=0, the corresponding PUSCH preparation time (N₂) is 10; When μ=1, the corresponding PUSCH preparation time (N₂) is 12; When μ=2, the corresponding PUSCH preparation time (N₂) is 23, and so on. When μ=6, the corresponding PUSCH preparation time (N₂) is 288.

For example, Table 4 below shows the corresponding relationship between the subcarrier spacing of the PUSCH and the PUSCH preparation time (N₂) at PUSCH timing capability 2.

TABLE 4
PUSCH preparation time for PUSCH timing capability 1

| μ | PUSCH preparation time N₂ [symbols] |
|---|---|
| 0 | 5 |
| 1 | 5.5 |
| 2 | 11 for frequency range 1 |

As shown in Table 4, at PUSCH timing capability 2, when μ=0, the corresponding PUSCH preparation time (N₂) is 5; When μ=1, the corresponding PUSCH preparation time (N₂) is 5.5; When μ=2, the corresponding PUSCH preparation time (N₂) is 11, which is used for frequency range 1.

It may be seen from Table 3 and Table 4 that at the same subcarrier spacing, the PUSCH preparation time for PUSCH timing capability 2 is smaller than the PUSCH preparation time for PUSCH timing capability 1, that is, the PUSCH preparation time of the UE with PUSCH timing capability 2 is shorter.

In the study item of R18, it is proposed to relax the processing time (the PDSCH processing time and the PUSCH preparation time) of the terminal, for example, to relax the processing time to n times of a certain processing capability in R15 (where n may be an integer greater than 1) so as to reduce the cost of the terminal. The terminal supporting this relaxation of the processing time is called an enhanced reduced capability (eRedCap) terminal. However, there is still a lack of effective means to support the relaxation of the processing capability of the eRedCap terminal.

Based on the above problem, the present disclosure proposes a method for reporting a terminal processing capability, a data processing method and apparatuses therefor, defines three terminal processing capabilities (processing capability ½ and a relaxed processing capability) existing in a New Radio (NR) system, clarifies the support situation of the processing capability of the eRedCap terminal, and sends information indicating the terminal processing capability supported by a terminal to a network device, so that the network device configures a processing capability of the terminal based on the information, so as to support the relaxation of the processing capability of the eRedCap terminal.

In order to better understand the method for reporting the terminal processing capability disclosed in embodiments of the present disclosure, a communication system to which the embodiments of the present disclosure applies will be described first.

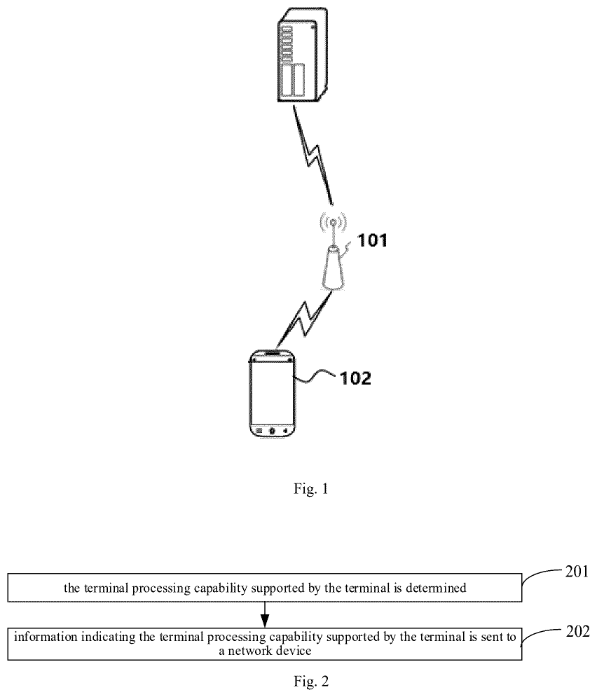

Referring to FIG. 1, which is a schematic architecture diagram of a communication system provided by an embodiment of the present disclosure. The communication system may include, but is not limited to, one network device and one terminal. The number and form of devices shown in FIG. 1 are only for illustration and do not constitute a limitation to the embodiments of the present disclosure. In practical applications, two or more network devices and two or more terminals may be provided. The communication system shown in FIG. 1 includes one network device 101 and one terminal 102 as an example.

It may be noted that the technical scheme in the embodiments of the present disclosure may be applied to various communication systems. For example, a long term evolution (LTE) system, a 5th generation (5G) mobile communication system, a 5G new radio (NR) system, or other new mobile communication systems in the future.

The network device 101 in the embodiments of the present disclosure is an entity on a network side for transmitting or receiving signals. For example, the network device 101 may be an evolved NodeB (eNB), a transmission reception point (TRP), a next generation NodeB (gNB) in the NR system, a base station in other future mobile communication systems or an access node in a wireless fidelity (WiFi) system. The embodiments of the present disclosure do not limit the specific technology and the specific equipment form adopted by the network device. The network device provided by the embodiments of the present disclosure may include a central unit (CU) and a distributed unit (DU), in which the CU may also be called a control unit. With the CU-DU structure, the protocol layers of the network device, such as the base station, may be separated, and functions of some protocol layers are centralized and controlled by the CU, while functions of some or all of the remaining protocol layers are distributed in the DU, and the DU is centrally controlled by the CU.

The terminal 102 in the embodiments of the present disclosure is an entity on a user side for receiving or transmitting signals, such as a mobile phone. The terminal may also be called a terminal device, user equipment (UE), a mobile station (MS), a mobile terminal (MT) and so on. The terminal may be a vehicle with a communication function, a smart vehicle, a mobile phone, a wearable device, a Pad, a computer with a wireless transceiver function, a virtual reality (VR) terminal, an augmented reality (AR) terminal, a wireless terminal in industrial control, a wireless terminal in self-driving, a wireless terminal in a remote medical surgery, a wireless terminal in a smart grid, a wireless terminal in transportation safety, a wireless terminal in a smart city, a wireless terminal in a smart home, etc. The embodiments of the present disclosure do not limit the specific technology and the specific equipment form adopted by the terminal.

It may be understood that the communication system described in the embodiments of the present disclosure is for more clearly explaining the technical scheme in the embodiments of the present disclosure, and does not constitute a limitation on the technical scheme provided by the embodiments of the present disclosure. Those skilled in the art know that with the evolution of the system architecture and the emergence of new business scenarios, the technical scheme provided by the embodiments of the present disclosure is also applicable to similar technical problems.

Next, the method for reporting the terminal processing capability, the data processing method and the apparatuses therefor provided by the present disclosure will be introduced in detail with reference to the accompanying drawings.

Referring to FIG. 2, FIG. 2 is a flow chart of a method for reporting a terminal processing capability provided by an embodiment of the present disclosure. It may be noted that the method for reporting the terminal processing capability according to the embodiment of the present disclosure may be executed by a terminal. As shown in FIG. 2, the method may include, but is not limited to, the following steps.

In step 201, the terminal processing capability supported by the terminal is determined.

The terminal involved in the embodiment of the present disclosure may be an eRedCap terminal. The terminal processing capability includes at least one of a first processing capability, a second processing capability and a third processing capability. The first processing capability is lower than the second processing capability, and the third processing capability is lower than the first processing capability.

It may be understood that the NR system may support not only an enhanced mobile broadband (eMBB) service, but also a variety of other service types, such as data transmission services of various Internet of Things devices in the Internet of Things scene. The terminal supporting these services has the characteristics of a reduced bandwidth, a reduced processing speed, a reduced number of antennas, etc. This kind of terminal is called a reduced capability (RedCap) terminal. The RedCap terminal includes typical bandwidths of 5 MHz, 10 MHz and 20 MHz. The terminal involved in the embodiment of the present disclosure is an eRedCap terminal. A maximum bandwidth of the eRedCap terminal is smaller than a maximum bandwidth of the RedCap terminal, and/or a processing speed of the eRedCap terminal is slower than a processing speed of the RedCap terminal, and/or, the number of antennas of the eRedCap terminal is less than the number of antennas of the RedCap terminal, and/or a peak data rate supported by the eRedCap terminal is lower than a peak data rate supported by the RedCap terminal.

In a possible implementation, processing time requirements of channels/signals of the eRedCap terminal may be further relaxed based on UE processing capability 1, for example, relaxed to twice the original. For example, in the study item of R18, it is proposed to relax a processing time (a PDSCH processing time N1 and a PUSCH preparation time N2) of the terminal. For example, the processing time is relaxed to twice a processing time for UE processing capability 1 in R15, so as to reduce the cost of the terminal. That is, there are terminals with three terminal processing capabilities (or called user processing capabilities) in the NR system. As an example, the three terminal processing capabilities include the first processing capability, the second processing capability and the third processing capability. For example, the first processing capability may be denoted as UE processing capability 1, the second processing capability may be denoted as UE processing capability 2 and the third processing capability may be denoted as UE processing capability 1′. The first processing capability is lower than the second processing capability, and the third processing capability is lower than the first processing capability. For example, the third processing capability is relaxed to half of the first processing capability.

For example, taking that the first processing capability is UE processing capability 1 and the third processing capability is relaxed to half of the first processing capability as an example, as shown in Table 1 above, in a case of the first processing capability (that is, UE processing capability 1), regarding the PDSCH processing time of the terminal (e.g., UE), when the subcarrier spacing μ=0, the corresponding PDSCH processing time (N₁) is 8, and the third processing capability is relaxed to half of the first processing capability. Thus, in a case of the third processing capability, regarding the PDSCH processing time of the terminal (e.g., the UE), when the subcarrier spacing μ=0, the corresponding PDSCH processing time (N₁) is 16. When the subcarrier spacing μ=1, the corresponding PDSCH processing time (N₁) is 10, and the third processing capability is relaxed to half of the first processing capability. Thus, in a case of the third processing capability, regarding the PDSCH processing time of the terminal (e.g., the UE), when the subcarrier spacing μ=1, the corresponding PDSCH processing time (N₁) is 20. When the subcarrier spacing μ=2, the corresponding PDSCH processing time (N₁) is 17, and the third processing capability is relaxed to half of the first processing capability. Thus, in a case of the third processing capability, regarding the PDSCH processing time of the terminal (e.g., the UE), when the subcarrier spacing μ=2, the corresponding PDSCH processing time (N₁) is 34. Similarly, when the subcarrier spacing μ=6, the corresponding PDSCH processing time (N₁) is 160, and the third processing capability is relaxed to half of the first processing capability. Thus, in a case of the third processing capability, regarding the PDSCH processing time of the terminal (e.g., the UE), when the subcarrier spacing μ=6, the corresponding PDSCH processing time (N₁) is 320.

For another example, taking that the first processing capability is UE processing capability 1 and the third processing capability is relaxed to half of the first processing capability as an example, as shown in Table 3 above, in a case of the first processing capability (i.e., UE processing capability 1), regarding the PUSCH preparation time of the terminal (e.g., the UE), when the subcarrier spacing μ=0, the corresponding PUSCH preparation time (N₂) is 10, and the third processing capability is relaxed to half of the first processing capability. Thus, in a case of the third processing capability, regarding the PUSCH preparation time of the terminal (e.g., the UE), when the subcarrier spacing μ=0, the corresponding PUSCH preparation time (N₂) is 20. When the subcarrier spacing μ=1, the corresponding PUSCH preparation time (N₂) is 12, and the third processing capability is relaxed to half of the first processing capability. Thus, in a case of the third processing capability, regarding the PUSCH preparation time of the terminal (e.g., the UE), when the subcarrier spacing μ=1, the corresponding PUSCH preparation time (N₂) is 24. When the subcarrier spacing μ=2, the corresponding PUSCH preparation time (N₂) is 23, and the third processing capability is relaxed to half of the first processing capability. Thus, in a case of the third processing capability, regarding the PUSCH preparation time of the terminal (e.g., the UE), when the subcarrier spacing μ=2, the corresponding PUSCH preparation time (N₂) is 46. Similarly, when the subcarrier spacing μ=6, the corresponding PUSCH preparation time (N₂) is 288, and the third processing capability is relaxed to half of the first processing capability. Thus, in a case of the third processing capability, regarding the PUSCH preparation time of the terminal (e.g., the UE), when the subcarrier spacing μ=6, the corresponding PUSCH preparation time (N₂) is 576.

It may be understood that the twice mentioned in the present disclosure is only illustrative, and the processing time may also be relaxed to 1.5 times, or 3 times, etc. in specific implementations, which is not limited in the present disclosure. Accordingly, the half mentioned in the present disclosure is only illustrative, and the processing capability may also be relaxed to two thirds (⅔) or one third (⅓), etc. in specific implementations, which is not limited in the present disclosure.

It may be noted that since there are terminals with three terminal processing capabilities in the NR system, and the eRedCap terminal may be further relaxed based on UE processing capability 1, there are eRedCap terminals, that may support the above three terminal processing capabilities, such as the first processing capability, the second processing capability and the third processing capability, in the NR system; or, all the eRedCap terminals in the NR system only support the above third processing capability.

In the embodiment of the present disclosure, when reporting the terminal processing capability of the terminal to a network device, the terminal may first determine the terminal processing capability it supports based on its own implementation and/or protocol stipulations.

In step 202, information indicating the terminal processing capability supported by the terminal is sent to a network device.

In some embodiments, after determining the terminal processing capability supported by the terminal, the terminal may send the information to the network device, and the information may indicate the terminal processing capability supported by the terminal. The network device may determine the terminal processing capability supported by the terminal through the information. In some embodiments, the network device may configure the terminal processing capability of the terminal after determining the terminal processing capability supported by the terminal. The terminal may determine to enable a corresponding processing capability for data channel and/or signal processing through the configuration for the terminal processing capability by the network device.

It may be noted that there may be the eRedCap terminals in the NR system, that support the above three terminal processing capabilities, such as the first processing capability, the second processing capability and the third processing capability; or, all the eRedCap terminals in the NR system only support the third processing capability. Thus, the terminal in the NR system needs to report the processing capability to inform the network device of the terminal processing capability supported by the terminal. The terminal processing capability supported by the terminal may be at least one of the above three terminal processing capabilities (i.e., the first processing capability, the second processing capability and the third processing capability).

As an example, the terminal processing capability supported by the eRedCap terminal in the NR system has the following situations.

The eRedCap terminal may support the first processing capability, the second processing capability and the third processing capability. For example, the processing capability supported by one eRedCap terminal may be implemented based on the terminal itself and/or stipulated by protocols. For example, one eRedCap terminal may specifically support one or more of the first processing capability, the second processing capability and the third processing capability based on its own implementation and/or protocol stipulations.

The eRedCap terminal may support the first processing capability and the third processing capability. For example, the processing capability supported by one eRedCap terminal may be implemented based on the terminal itself and/or stipulated by protocols, for example, one eRedCap terminal may specifically support one or more of the first processing capability and the third processing capability based on its own implementation and/or protocol stipulations.

The eRedCap terminal only supports the third processing capability. For example, one eRedCap terminal only supports the third processing capability.

It may also be noted that since the above three terminal processing capabilities include the optional capability and the default capability not reported using terminal capability signaling, in the embodiment of the present disclosure, the information sent by the terminal to the network device may be the terminal capability signaling for reporting the terminal processing capability, or it may be information for implicitly indicating to the network device that the terminal supports the default capability. For example, in a case that the optional capability supported by the terminal is not reported in the information, it may implicitly indicate to the network device that the terminal supports the default capability.

It may also be noted that in the embodiment of the present disclosure, a certain one of the first processing capability, the second processing capability and the third processing capability is a default capability for one or more of uplink transmission/downlink transmission/channel state information (CSI), while is an optional capability for processing of other channels/signals. In some embodiments, in a case that the terminal reports the capability once in an initial access stage, it is unnecessary to report the processing capability again in the terminal (e.g., UE) capability signaling.

By implementing the embodiment of the present disclosure, the support situation of the processing capability of the eRedCap terminal is clarified by defining that three terminal processing capabilities (processing capability ½ and relaxed processing capability) exist in the NR system, and the information indicating the terminal processing capability supported by the terminal is sent to the network device, so that the network device configures the processing capability of the terminal based on the information, so as to support the relaxation of the processing capability of the eRedCap terminal.

It may be noted that there may be the eRedCap terminals in the NR system, that support the above three terminal processing capabilities, such as the first processing capability, the second processing capability and the third processing capability. In an implementation, the eRedCap terminal is a terminal configured to support the first processing capability, the second processing capability and the third processing capability, in which the first processing capability and the second processing capability are optional capabilities respectively, and the third processing capability is a default capability in a case that the terminal processing capability is not reported. In another implementation, the eRedCap terminal is a terminal configured to support the first processing capability, the second processing capability and the third processing capability, in which the second processing capability and the third processing capability are optional capabilities respectively, and the first processing capability is a default capability in a case that the terminal processing capability is not reported. Since the optional capabilities and default capabilities supported by the eRedCap terminals are different, the methods for reporting the terminal processing capabilities will be different. Various implementation methods of reporting the terminal processing capabilities will be described with reference to embodiments in the following.

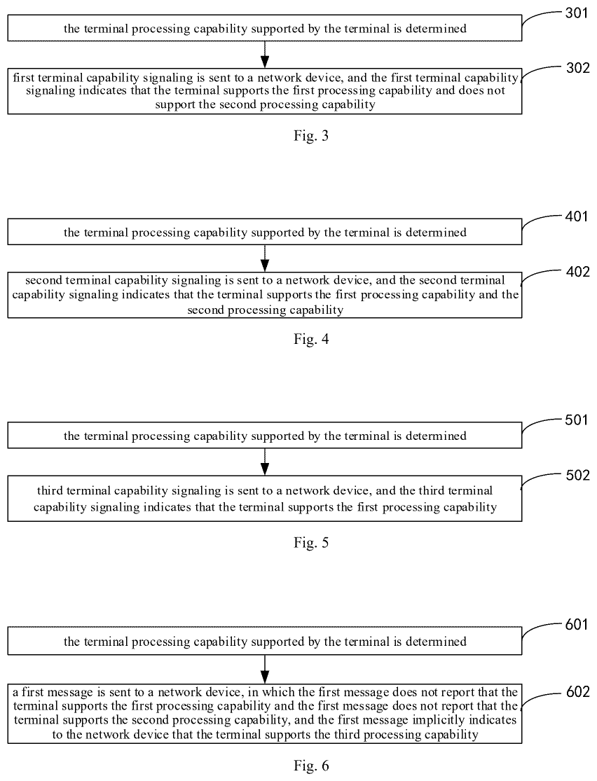

Referring to FIG. 3, FIG. 3 is a flow chart of another method for reporting a terminal processing capability provided by an embodiment of the present disclosure. It may be noted that the method for reporting the terminal processing capability according to the embodiment of the present disclosure may be performed by a terminal. As shown in FIG. 3, the method may include, but is not limited to, the following steps.

In step 301, the terminal processing capability supported by the terminal is determined.

In the embodiment of the present disclosure, an eRedCap terminal is a terminal that may support the first processing capability, the second processing capability and the third processing capability. The first processing capability and the second processing capability are optional capabilities respectively, and the third processing capability is a default capability in a case that the terminal processing capability is not reported. In the embodiment of the present disclosure, the first processing capability and the second processing capability are optional capabilities and need to be reported through terminal processing signaling, and the third processing capability is the default capability and may not be reported through the terminal processing signaling.

In some embodiments of the present disclosure, the first processing capability may be separately reported for uplink transmission, downlink transmission and channel state information (CSI) calculation; or, the first processing capability may be combinatively reported for at least two of uplink transmission, downlink transmission and CSI calculation. That is, the uplink transmission, the downlink transmission and the channel state information (CSI) calculation may have separate terminal capability signaling for reporting the first processing capability. Alternatively, at least two of the uplink transmission, the downlink transmission and the channel state information (CSI) calculation may be combined for reporting the first processing capability. For example, the uplink transmission and the downlink transmission may use the same terminal capability signaling for reporting the first processing capability, or the uplink transmission and the CSI calculation may use the same terminal capability signaling for reporting the first processing capability, or the downlink transmission and the CSI calculation may use the same terminal capability signaling for reporting the first processing capability, or the uplink transmission, the downlink transmission and the CSI calculation may use the same terminal capability signaling for reporting the first processing capability.

In the embodiment of the present disclosure, step 301 may be realized by any one of the embodiments of the present disclosure, which is not limited in the embodiment of the present disclosure and will not be repeated here.

In step 302, first terminal capability signaling is sent to a network device, and the first terminal capability signaling indicates that the terminal supports the first processing capability and does not support the second processing capability.

In an implementation, for the eRedCap terminal, the reporting design of two optional capabilities (i.e., the first processing capability and the second processing capability) is as follows: the first processing capability is reported only in a case that the first processing capability is supported and the second processing capability is not supported. In an embodiment of the present disclosure, in a case that the eRedCap terminal determines that it supports the first processing capability and does not support the second processing capability, the eRedCap terminal may send the first terminal capability signaling to the network device, to report the processing capability in the first terminal capability signaling. The first terminal capability signaling may indicate that the terminal supports the first processing capability and does not support the second processing capability.

By implementing the embodiment of the present disclosure, the support situation of the processing capability of the eRedCap terminal is clarified by defining that the terminals (that is, the eRedCap terminals) with three terminal processing capabilities exist in the NR system, and the first terminal capability signaling is sent to the network device, to indicate to the network device that the terminal supports the first processing capability and does not support the second processing capability through the first terminal capability signaling, so that the network device may know the situation of the terminal processing capability supported by the terminal, and make configuration based on the situation of the terminal processing capability supported by the terminal, so as to support the relaxation of the processing capability of the eRedCap terminal.

Referring to FIG. 4, FIG. 4 is a flow chart of another method for reporting a terminal processing capability provided by an embodiment of the present disclosure. It may be noted that the method for reporting the terminal processing capability according to the embodiment of the present disclosure may be performed by a terminal. As shown in FIG. 4, the method may include, but is not limited to, the following steps.

In step 401, the terminal processing capability supported by the terminal is determined.

In the embodiment of the present disclosure, an eRedCap terminal is a terminal configured to support a first processing capability, a second processing capability and a third processing capability. The first processing capability and the second processing capability are optional capabilities respectively, and the third processing capability is a default capability in a case that the terminal processing capability is not reported. In the embodiment of the present disclosure, the first processing capability and the second processing capability are optional capabilities and need to be reported through terminal processing signaling, and the third processing capability is the default capability and may not be reported through the terminal processing signaling.

In the embodiment of the present disclosure, step 401 may be realized by any one of the embodiments of the present disclosure, which is not limited in the embodiment of the present disclosure and will not be repeated here.

In step 402, second terminal capability signaling is sent to a network device, and the second terminal capability signaling indicates that the terminal supports the first processing capability and the second processing capability.

In an implementation, for the eRedCap terminal, the reporting design of two optional capabilities (i.e., the first processing capability and the second processing capability) is as follows: in a case that the eRedCap terminal reports that it supports the second processing capability, it implicitly indicates to the network device that it supports the first processing capability, and the first processing capability does not need to be reported again.

In an embodiment of the present disclosure, in a case that the eRedCap terminal determines that it supports the first processing capability and the second processing capability, it may send the second terminal capability signaling to the network device, to report the processing capability in the second terminal capability signaling. The second terminal capability signaling can indicate that the terminal supports the second processing capability, and may also implicitly indicate to the network device that it supports the first processing capability, so that the first processing capability does not need to be reported again, thus saving signaling resources.

By implementing the embodiment of the present disclosure, the support situation of the processing capability of the eRedCap terminal is clarified by defining that three terminal processing capabilities (processing capability ½ and relaxed processing capability) exist in the NR system, and the second terminal capability signaling is sent to the network device, to indicate to the network device that the terminal supports the second processing capability, and implicitly indicate to the network device that the terminal supports the first processing capability, so that the first processing capability does not need to be reported again, thereby saving signaling resources. In addition, the network device may know the situation of the terminal processing capability supported by the terminal through the second terminal capability signaling, and make configuration based on the situation of the terminal processing capability supported by the terminal, so as to support the relaxation of the processing capability of the eRedCap terminal.

Referring to FIG. 5, FIG. 5 is a flow chart of another method for reporting a terminal processing capability provided by an embodiment of the present disclosure. It may be noted that the method for reporting the terminal processing capability according to the embodiment of the present disclosure may be performed by the terminal. As shown in FIG. 5, the method may include, but is not limited to, the following steps.

In step 501, the terminal processing capability supported by the terminal is determined.

In the embodiment of the present disclosure, an eRedCap terminal is a terminal configured to support a first processing capability, a second processing capability and a third processing capability. The first processing capability and the second processing capability are optional capabilities respectively, and the third processing capability is a default capability in a case that the terminal processing capability is not reported. In the embodiment of the present disclosure, the first processing capability and the second processing capability are optional capabilities and need to be reported through terminal processing signaling, and the third processing capability is the default capability and may not be reported through the terminal processing signaling.

In the embodiment of the present disclosure, step 501 may be realized by any one of the embodiments of the present disclosure, which is not limited in the embodiment of the present disclosure and will not be repeated here.

In step 502, third terminal capability signaling is sent to a network device, and the third terminal capability signaling indicates that the terminal supports the first processing capability.

In an embodiment of the present disclosure, the eRedCap terminal may send the third terminal capability signaling to the network device, to report the processing capability in the third terminal capability signaling. The third terminal capability signaling may indicate that the terminal supports the first processing capability. In some embodiments, the first processing capability and the second processing capability may be reported separately. For example, the terminal capability signaling indicating that the terminal supports the second processing capability does not implicitly indicate that the first processing capability is supported, and the first processing capability and the second processing capability are reported separately by different terminal processing capability signaling.

By implementing the embodiment of the present disclosure, the support situation of the processing capability of the eRedCap terminal is clarified by defining that three terminal processing capabilities (processing capability ½ and relaxed processing capability) exist in the NR system, and the third terminal capability signaling is sent to the network device, to indicate to the network device that the terminal supports the first processing capability through the third terminal capability signaling. In addition, through the third terminal capability signaling, the network device may know the situation of the terminal processing capability supported by the terminal, and make configuration based on the situation of the terminal processing capability supported by the terminal, so as to support the relaxation of the processing capability of the eRedCap terminal.

Referring to FIG. 6, FIG. 6 is a flow chart of another method for reporting a terminal processing capability provided by an embodiment of the present disclosure. It may be noted that the method for reporting the terminal processing capability according to the embodiment of the present disclosure may be performed by a terminal. As shown in FIG. 6, the method may include, but is not limited to, the following steps.

In step 601, the terminal processing capability supported by the terminal is determined.

In the embodiment of the present disclosure, an eRedCap terminal is a terminal configured to support a first processing capability, a second processing capability and a third processing capability. The first processing capability and the second processing capability are optional capabilities respectively, and the third processing capability is a default capability in which the terminal processing capability is not reported. In the embodiment of the present disclosure, the first processing capability and the second processing capability are optional capabilities and need to be reported through terminal processing signaling, and the third processing capability is the default capability and may not be reported through the terminal processing signaling.

In the embodiment of the present disclosure, step 601 may be realized by any one of the embodiments of the present disclosure, which is not limited in the embodiment of the present disclosure and will not be repeated here.

In step 602, a first message is sent to a network device, in which the first message does not report that the terminal supports the first processing capability and the first message does not report that the terminal supports the second processing capability, and the first message implicitly indicates to the network device that the terminal supports the third processing capability.

In some embodiments, since the third processing capability is a default capability of an eRedCap terminal, and the default capability may not be reported through terminal processing signaling, when the terminal sends capability reporting signaling to the network device, in a case that there is no terminal capability signaling for reporting the first processing capability and no terminal capability signaling for reporting the second processing capability in the signaling, it may implicitly indicate to the network device that the terminal supports the third processing capability, thus saving signaling resources.

In an implementation, the eRedCap terminal may send the first message to the network device when determining that it supports the first processing capability, the second processing capability and the third processing capability. Since the first message does not report that the terminal supports the first processing capability and the first message does not report that the terminal supports the second processing capability, the first message may implicitly indicate to the network device that the terminal supports the third processing capability.

By implementing the embodiment of the present disclosure, the support situation of the processing capability of the eRedCap terminal is clarified by defining that three terminal processing capabilities (processing capability ½ and relaxed processing capability) exist in the NR system, and the first message is sent to the network device, to implicitly indicate to the network device that the terminal supports the third processing capability through the first message. In addition, through the first message, the network device may know the situation of the terminal processing capability supported by the terminal, and make configuration based on the situation of the terminal processing capability supported by the terminal, so as to support the relaxation of the processing capability of the eRedCap terminal.

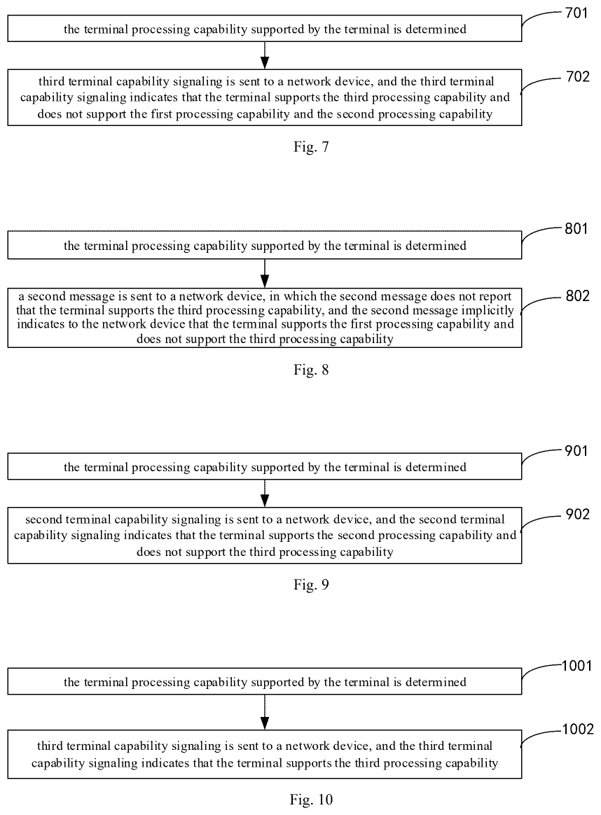

Referring to FIG. 7, FIG. 7 is a flow chart of another method for reporting a terminal processing capability provided by an embodiment of the present disclosure. It may be noted that the method for reporting the terminal processing capability according to the embodiment of the present disclosure may be performed by a terminal. As shown in FIG. 7, the method may include, but is not limited to, the following steps.

In step 701, the terminal processing capability supported by the terminal is determined.

In the embodiment of the present disclosure, an eRedCap terminal is a terminal configured to support a first processing capability, a second processing capability and a third processing capability. The second processing capability and the third processing capability are optional capabilities respectively, and the first processing capability is a default capability in a case that the terminal processing capability is not reported. In the embodiment of the present disclosure, the second processing capability and the third processing capability are optional capabilities and need to be reported through terminal processing signaling, and the first processing capability is the default capability and may not be reported through the terminal processing signaling.

In some embodiments of the present disclosure, the third processing capability may be reported separately for uplink transmission, downlink transmission and channel state information (CSI) calculation; or, the third processing capability may be combinatively reported for at least two of uplink transmission, downlink transmission and CSI calculation. That is, the uplink transmission, the downlink transmission and the channel state information (CSI) calculation may have separate terminal capability signaling for reporting the third processing capability. Alternatively, at least two of the uplink transmission, the downlink transmission and the channel state information (CSI) calculation may be combined for reporting the third processing capability. For example, the uplink transmission and the downlink transmission may use the same terminal capability signaling for reporting the third processing capability, or the uplink transmission and the CSI calculation may use the same terminal capability signaling for reporting the third processing capability, or the downlink transmission and the CSI calculation may use the same terminal capability signaling for reporting the third processing capability, or the uplink transmission, the downlink transmission and the CSI calculation may use the same terminal capability signaling for reporting the third processing capability.

In the embodiment of the present disclosure, step 701 may be realized by any one of the embodiments of the present disclosure, which is not limited in the embodiment of the present disclosure and will not be repeated here.

In step 702, third terminal capability signaling is sent to a network device, and the third terminal capability signaling indicates that the terminal supports the third processing capability and does not support the first processing capability and the second processing capability.

In an embodiment of the present disclosure, when the eRedCap terminal determines that it supports the third processing capability and does not support the first processing capability and the second processing capability, it may send the third terminal capability signaling to the network device, to report the processing capability in the third terminal capability signaling. The third terminal capability signaling may indicate that the terminal supports the third processing capability and does not support the first processing capability and the second processing capability. In an implementation, in a case that one eRedCap terminal reports that it supports the third processing capability, it means that the first processing capability and the second processing capability are no longer supported.

By implementing the embodiment of the present disclosure, the support situation of the processing capability of the eRedCap terminal is clarified by defining that three terminal processing capability (processing capability ½ and relaxed processing capability) exist in the NR system, and the third terminal capability signaling is sent to the network device, to indicate to the network device that the terminal supports the third processing capability and does not support the first processing capability and the second processing capability through the third terminal capability signaling, so that the network device may know the situation of the terminal processing capability supported by the terminal, and make configuration based on the situation of the terminal processing capability supported by the terminal, so as to support the relaxation of the processing capability of the eRedCap terminal.

Referring to FIG. 8, FIG. 8 is a flow chart of another method for reporting a terminal processing capability provided by an embodiment of the present disclosure. It may be noted that the method for reporting the terminal processing capability according to the embodiment of the present disclosure may be performed by a terminal. As shown in FIG. 8, the method may include, but is not limited to, the following steps.

In step 801, the terminal processing capability supported by the terminal is determined.

In the embodiment of the present disclosure, an eRedCap terminal is a terminal configured support a first processing capability, a second processing capability and a third processing capability. The second processing capability and the third processing capability are optional capabilities respectively, and the first processing capability is a default capability in a case that the terminal processing capability is not reported. In the embodiment of the present disclosure, the second processing capability and the third processing capability are optional capabilities and need to be reported through terminal processing signaling, and the first processing capability is the default capability and may not be reported through the terminal processing signaling.

In some embodiments of the present disclosure, the third processing capability may be separately reported for uplink transmission, downlink transmission and channel state information (CSI) calculation; or, the third processing capability may be combinatively reported for at least two of uplink transmission, downlink transmission and CSI calculation. That is, the uplink transmission, the downlink transmission and the channel state information (CSI) calculation may have separate terminal capability signaling for reporting the third processing capability. Alternatively, at least two of the uplink transmission, the downlink transmission and the channel state information (CSI) calculation may be combined for reporting the third processing capability. For example, the uplink transmission and the downlink transmission may use the same terminal capability signaling for reporting the third processing capability, or the uplink transmission and the CSI calculation may use the same terminal capability signaling for reporting the third processing capability, or the downlink transmission and the CSI calculation may use the same terminal capability signaling for reporting the third processing capability, or the uplink transmission, the downlink transmission and the CSI calculation may use the same terminal capability signaling for reporting the third processing capability.

In the embodiment of the present disclosure, step 801 may be realized by any one of the embodiments of the present disclosure, which is not limited in the embodiment of the present disclosure and will not be repeated here.

In step 802, a second message is sent to a network device, in which the second message does not report that the terminal supports the third processing capability, and the second message implicitly indicates to the network device that the terminal supports the first processing capability and does not support the third processing capability.

In an embodiment of the present disclosure, the eRedCap terminal may send the second message to the network device, the second message does not report that the third processing capability is reported, and the second message implicitly indicates to the network device that the terminal supports the first processing capability and does not support the third processing capability. In an implementation, in a case that one eRedCap terminal does not report that it supports the third processing capability, it means that the terminal does not support the third processing capability.

By implementing the embodiment of the present disclosure, the support situation of the processing capability of the eRedCap terminal is clarified by defining that three terminal processing capabilities (processing capability ½ and relaxed processing capability) exist in the NR system, and the second message is sent to the network device, to implicitly indicate to the network device that the terminal supports the first processing capability and does not support the third processing capability through the second message, so that the network device may know the situation of the terminal processing capability supported by the terminal, and make configuration based on the situation of the terminal processing capability supported by the terminal, so as to support the relaxation of the processing capability of the eRedCap terminal.

Referring to FIG. 9, FIG. 9 is a flow chart of another method for reporting a terminal processing capability provided by an embodiment of the present disclosure. It may be noted that the method for reporting the terminal processing capability according to the embodiment of the present disclosure may be performed by a terminal. As shown in FIG. 9, the method may include, but is not limited to, the following steps.

In step 901, the terminal processing capability supported by the terminal is determined.

In the embodiment of the present disclosure, an eRedCap terminal is a terminal configured to support a first processing capability, a second processing capability and a third processing capability. The second processing capability and the third processing capability are optional capabilities respectively, and the first processing capability is a default capability in a case that the terminal processing capability is not reported. In the embodiment of the present disclosure, the second processing capability and the third processing capability are optional capabilities and need to be reported through terminal processing signaling, and the first processing capability is the default capability and may not be reported through the terminal processing signaling.

In some embodiments of the present disclosure, the third processing capability may be separately reported for uplink transmission, downlink transmission and channel state information (CSI) calculation; or, the third processing capability may be combinatively reported for at least two of uplink transmission, downlink transmission and CSI calculation. That is, the uplink transmission, the downlink transmission and the channel state information (CSI) calculation may have separate terminal capability signaling for reporting the third processing capability. Alternatively, at least two of the uplink transmission, the downlink transmission and the channel state information (CSI) calculation may be combined for reporting the third processing capability. For example, the uplink transmission and the downlink transmission may use the same terminal capability signaling for reporting the third processing capability, or the uplink transmission and the CSI calculation may use the same terminal capability signaling for reporting the third processing capability, or the downlink transmission and the CSI calculation may use the same terminal capability signaling for reporting the third processing capability, or the uplink transmission, the downlink transmission and the CSI calculation may use the same terminal capability signaling for reporting the third processing capability.

In the embodiment of the present disclosure, step 901 may be realized by any one of the embodiments of the present disclosure, which is not limited in the embodiment of the present disclosure and will not be repeated here.

In step 902, second terminal capability signaling is sent to a network device, and the second terminal capability signaling indicates that the terminal supports the second processing capability and does not support the third processing capability.

In an implementation, the second processing capability and the third processing capability cannot be reported simultaneously. In an embodiment of the present disclosure, the eRedCap terminal may send the second terminal capability signaling to the network device, to report the processing capability in the second terminal capability signaling. The second terminal capability signaling indicates that the terminal supports the second processing capability and does not support the third processing capability.

By implementing the embodiment of the present disclosure, the support situation of the processing capability of the eRedCap terminal is clarified by defining that three terminal processing capabilities (processing capability ½ and relaxed processing capability) exist in the NR system, and the second terminal capability signaling is sent to the network device, to indicate to the network device that the terminal supports the second processing capability and does not support the third processing capability through the second terminal capability signaling, so that the network device may know the situation of the terminal processing capability supported by the terminal, and make configuration based on the situation of the terminal processing capability supported by the terminal, so as to support the relaxation of the processing capability of the eRedCap terminal.

Referring to FIG. 10, FIG. 10 is a flow chart of another method for reporting a terminal processing capability provided by an embodiment of the present disclosure. It may be noted that the method for reporting the terminal processing capability according to the embodiment of the present disclosure may be performed by a terminal. As shown in FIG. 10, the method may include, but is not limited to, the following steps.

In step 1001, the terminal processing capability supported by the terminal is determined.

In the embodiment of the present disclosure, an eRedCap terminal is a terminal configured to support a first processing capability, a second processing capability and a third processing capability. The second processing capability and the third processing capability are optional capabilities respectively, and the first processing capability is a default capability in a case that the terminal processing capability is not reported. In the embodiment of the present disclosure, the second processing capability and the third processing capability are optional capabilities and need to be reported through terminal processing signaling, and the first processing capability is the default capability and may not be reported through the terminal processing signaling.

In some embodiments of the present disclosure, the third processing capability may be separately reported for uplink transmission, downlink transmission and channel state information (CSI) calculation; or, the third processing capability may be combinatively reported for at least two of uplink transmission, downlink transmission and CSI calculation. That is, the uplink transmission, the downlink transmission and the channel state information (CSI) calculation may have separate terminal capability signaling for reporting the third processing capability. Alternatively, at least two of the uplink transmission, the downlink transmission and the channel state information (CSI) calculation may be combined for reporting the third processing capability. For example, the uplink transmission and the downlink transmission may use the same terminal capability signaling for reporting the third processing capability, or the uplink transmission and the CSI calculation may use the same terminal capability signaling for reporting the third processing capability, or the downlink transmission and the CSI calculation may use the same terminal capability signaling for reporting the third processing capability, or the uplink transmission, the downlink transmission and the CSI calculation may use the same terminal capability signaling for reporting the third processing capability.

In the embodiment of the present disclosure, step 1001 may be realized by any one of the embodiments of the present disclosure, which is not limited in the embodiment of the present disclosure and will not be repeated here.

In step 1002, third terminal capability signaling is sent to a network device, and the third terminal capability signaling indicates that the terminal supports the third processing capability.

In an embodiment of the present disclosure, the eRedCap terminal may send the third terminal capability signaling to the network device, to report the processing capability in the third terminal capability signaling, and the third terminal capability signaling indicates that the terminal supports the third processing capability.

By implementing the embodiment of the present disclosure, the support situation of the processing capability of the eRedCap terminal is clarified by defining that three terminal processing capabilities (processing capability ½ and relaxed processing capability) exist in the NR system, and the third terminal capability signaling is sent to the network device, to indicate that the terminal supports the third processing capability through the third terminal capability signaling, so that the network device may know the situation of the terminal processing capability supported by the terminal, and make configuration based on the situation of the terminal processing capability supported by the terminal.

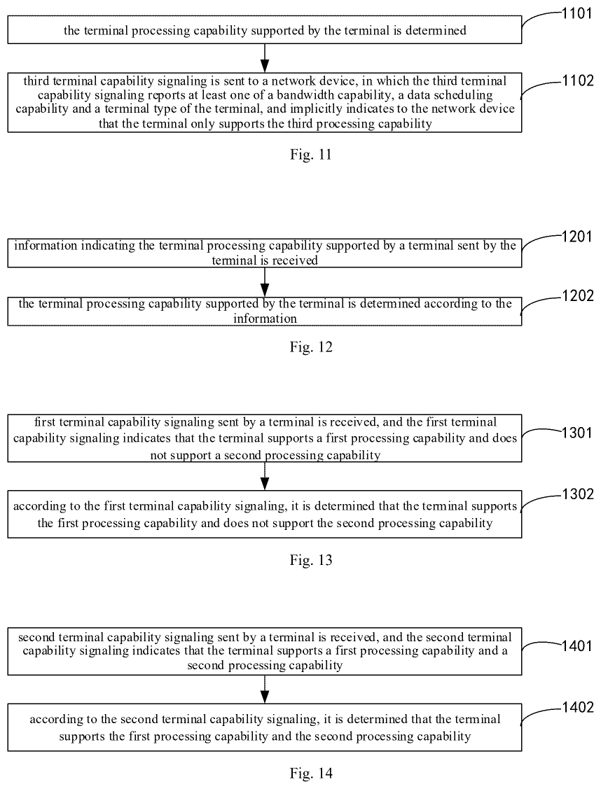

It may be noted that all the eRedCap terminals in the NR system only support the third processing capability. In an implementation, the eRedCap terminal is a terminal that only supports the third processing capability. In an embodiment of the present disclosure, all of the uplink transmission, the downlink transmission and the CSI calculation may only support the third processing capability. In some embodiments, referring to FIG. 11, FIG. 11 is a flow chart of another method for reporting a terminal processing capability provided by an embodiment of the present disclosure. It may be noted that the method for reporting the terminal processing capability according to the embodiment of the present disclosure may be performed by a terminal. As shown in FIG. 11, the method may include, but is not limited to, the following steps.

In step 1101, the terminal processing capability supported by the terminal is determined.

In the embodiment of the present disclosure, the terminal may be an eRedCap terminal, and the terminal processing capability includes at least one of a first processing capability, a second processing capability and a third processing capability. The first processing capability is lower than the second processing capability, and the third processing capability is lower than the first processing capability.

In the embodiment of the present disclosure, the eRedCap terminal is a terminal that only supports the third processing capability.

In the embodiment of the present disclosure, step 1101 may be realized by any one of the embodiments of the present disclosure, which is not limited in the embodiment of the present disclosure and will not be repeated here.

In step 1102, third terminal capability signaling is sent to a network device, in which the third terminal capability signaling reports at least one of a bandwidth capability, a data scheduling capability and a terminal type of the terminal, and implicitly indicates to the network device that the terminal only supports the third processing capability.

In an implementation, the eRedCap terminal does not need to report the terminal processing capability in the terminal capability signaling, and the eRedCap terminal may report its bandwidth capability and/or data scheduling capability and/or terminal type in the terminal (e.g., UE) capability signaling, which implicitly indicates that the terminal only supports the third processing capability. In an embodiment of the present disclosure, the eRedCap terminal may send the third terminal capability signaling to the network device when determining that it only supports the third processing capability, to report at least one of the bandwidth capability, the data scheduling capability and the terminal type of the terminal in the third terminal capability signaling, and implicitly indicate to the network device that the terminal only supports the third processing capability through the third terminal capability signaling.

By implementing the embodiment of the present disclosure, the support situation of the processing capability of the eRedCap terminal is clarified by defining that three terminal processing capabilities (processing capability ½ and relaxed processing capability) exist in the NR system, and the third terminal capability signaling is sent to the network device, to implicitly indicate to the network device that the terminal only supports the third processing capability through the third terminal capability signaling, so that the network device may know the situation of the terminal processing capability supported by the terminal, and make configuration based on the situation of the terminal processing capability supported by the terminal, so as to support the relaxation of the processing capability of the eRedCap terminal.

An embodiment of the present disclosure also provides a method for determining a terminal processing capability. The network device may determine the terminal processing capability supported by the terminal through the information sent by the terminal. Referring to FIG. 12, FIG. 12 is a flow chart of a method for determining a terminal processing capability provided by an embodiment of the present disclosure. It may be noted that the method for determining the terminal processing capability according to the embodiment of the present disclosure may be performed by a network device. As shown in FIG. 12, the method may include, but is not limited to, the following steps.

In step 1201, information indicating the terminal processing capability supported by a terminal sent by the terminal is received.

In the embodiment of the present disclosure, the terminal may be an eRedCap terminal, and the terminal processing capability includes at least one of a first processing capability, a second processing capability and a third processing capability. The first processing capability is lower than the second processing capability, and the third processing capability is lower than the first processing capability.

It may be understood that the NR system may support not only an eMBB service, but also a variety of other service types, such as data transmission services of various Internet of Things devices in the Internet of Things scene. The terminal supporting these services has the characteristics of a reduced bandwidth, a reduced processing speed, a reduced number of antennas, etc. This kind of terminal is called a RedCap terminal. The RedCap terminal includes typical bandwidths of 5 MHz, 10 MHz and 20 MHz. The terminal involved in the embodiment of the present disclosure is the eRedCap terminal. The bandwidth of the eRedCap terminal is smaller than the bandwidth of the RedCap terminal, and/or a processing speed of the eRedCap terminal is slower than a processing speed of the RedCap terminal, and/or, the number of antennas of the eRedCap terminal is less than the number of antennas of the RedCap terminal.

In a possible implementation, the eRedCap terminal (specifically, the processing time) may be further relaxed based on UE processing capability 1, for example, relaxed to twice the original. For example, in the study item of R18, it is proposed to relax a processing time (a PDSCH processing time N1 and a PUSCH preparation time N2) of the terminal. For example, the processing time is relaxed to twice a processing time for UE processing capability 1 in R15, so as to reduce the cost of the terminal. That is, there are terminals with three terminal processing capabilities (or called user processing capabilities) in the NR system. As an example, the three terminal processing capabilities include the first processing capability, the second processing capability and the third processing capability. For example, the first processing capability may be denoted as UE processing capability 1, the second processing capability may be denoted as UE processing capability 2 and the third processing capability may be denoted as UE processing capability 1′. The first processing capability is lower than the second processing capability, and the third processing capability is lower than the first processing capability. For example, the third processing capability is relaxed to half of the first processing capability.

It may be noted that since there are terminals with three terminal processing capabilities in the NR system, and the eRedCap terminal may be further relaxed based on UE processing capability 1, there are eRedCap terminals, that may support the above three terminal processing capabilities, such as the first processing capability, the second processing capability and the third processing capability, in the NR system; or, all the eRedCap terminals in the NR system only support the third processing capability.

In the embodiment of the present disclosure, the network device may receive the information indicating the terminal processing capability supported by the terminal sent by the terminal.

In step 1202, the terminal processing capability supported by the terminal is determined according to the information.

In an implementation, in a case that the eRedCap terminal reports its terminal processing capability to the network device, it may first determine the terminal processing capability supported by itself, and then send the information indicating the terminal processing capability supported by the terminal to the network device. The network device may know the situation of the terminal processing capability supported by the terminal through the information sent by the terminal.

In some embodiments, the network device can configure the terminal processing capability of the terminal after determining the terminal processing capability supported by the terminal. The terminal may determine to enable a corresponding processing capability for data channel and/or signal processing through the configuration for the terminal processing capability by the network device.

It may be noted that there may be the eRedCap terminals in the NR system, that support the above three terminal processing capabilities, such as the first processing capability, the second processing capability and the third processing capability; or, all the eRedCap terminals in the NR system only support the third processing capability. Thus, the eRedCap terminal sends the above information to the network device to inform it that the terminal processing capability supported by the terminal may include at least one of the above three terminal processing capabilities.

It may also be noted that since the above three terminal processing capabilities include an optional capability and a default capability not reported using terminal capability signaling, in the embodiment of the present disclosure, the above information may be the terminal capability signaling for reporting the terminal processing capability, or it may be information for implicitly indicating to the network device that the terminal supports the default capability. For example, in a case that the optional capability supported by the terminal is not reported in the information, it may implicitly indicate to the network device that the terminal supports the default capability.

By implementing the embodiment of the present disclosure, the support situation of the processing capability of the eRedCap terminal is clarified by defining that three terminal processing capabilities (processing capability ½ and relaxed processing capability) exist in the NR system, and the information indicating the terminal processing capability supported by the terminal is sent to the network device by the terminal, so that the network device configures the processing capability of the terminal based on the information, so as to support the relaxation of the processing capability of the eRedCap terminal.

It may be noted that there may be the eRedCap terminals in the NR system, that support the above three terminal processing capabilities, such as the first processing capability, the second processing capability and the third processing capability. In an implementation, the eRedCap terminal is a terminal configured to support the first processing capability, the second processing capability and the third processing capability, in which the first processing capability and the second processing capability are optional capabilities respectively, and the third processing capability is a default capability in a case that the terminal processing capability is not reported. In another implementation, the eRedCap terminal is a terminal configured to support the first processing capability, the second processing capability and the third processing capability, in which the second processing capability and the third processing capability are optional capabilities respectively, and the first processing capability is a default capability in which the terminal processing capability is not reported. Since the optional capabilities and default capabilities supported by the eRedCap terminals are different, the methods for reporting the terminal processing capability are different, and thus the methods for the network device to determine the terminal processing capability are different. Various implementation methods for determining the terminal processing capability will be described with reference to embodiments in the following.

Referring to FIG. 13, FIG. 13 is a flow chart of a method for determining a terminal processing capability provided by an embodiment of the present disclosure. It may be noted that the method for determining the terminal processing capability according to the embodiment of the present disclosure may be performed by a network device. As shown in FIG. 13, the method may include, but is not limited to, the following steps.

In step 1301, first terminal capability signaling sent by a terminal is received, and the first terminal capability signaling indicates that the terminal supports a first processing capability and does not support a second processing capability.

In the embodiment of the present disclosure, the terminal may be an eRedCap terminal, and the terminal processing capability includes at least one of a first processing capability, a second processing capability and a third processing capability. The first processing capability is lower than the second processing capability, and the third processing capability is lower than the first processing capability.

In the embodiment of the present disclosure, the eRedCap terminal is a terminal configured to support the first processing capability, the second processing capability and the third processing capability. The first processing capability and the second processing capability are optional capabilities respectively, and the third processing capability is a default capability in a case that the terminal processing capability is not reported. In the embodiment of the present disclosure, the first processing capability and the second processing capability are optional capabilities and need to be reported through terminal processing signaling, and the third processing capability is the default capability and may not be reported through the terminal processing signaling.

In some embodiments of the present disclosure, the first processing capability may be separately reported for uplink transmission, downlink transmission and channel state information (CSI) calculation; or, the first processing capability may be combinatively reported for at least two of uplink transmission, downlink transmission and CSI calculation. That is, the uplink transmission, the downlink transmission and the channel state information (CSI) calculation may have separate terminal capability signaling for reporting the first processing capability. Alternatively, at least two of the uplink transmission, the downlink transmission and the channel state information (CSI) calculation may be combined for reporting the first processing capability. For example, the uplink transmission and the downlink transmission may use the same terminal capability signaling for reporting the first processing capability, or the uplink transmission and the CSI calculation may use the same terminal capability signaling for reporting the first processing capability, or the downlink transmission and the CSI calculation may use the same terminal capability signaling for reporting the first processing capability, or the uplink transmission, the downlink transmission and the CSI calculation may use the same terminal capability signaling for reporting the first processing capability.

In an implementation, for the eRedCap terminal, the reporting design of two optional capabilities (i.e., the first processing capability and the second processing capability) is as follows: the first processing capability is reported only in a case that the first processing capability is supported and the second processing capability is not supported. In an embodiment of the present disclosure, in a case that the eRedCap terminal determines that it supports the first processing capability and does not support the second processing capability, it may send the first terminal capability signaling to the network device, to report the processing capability in the first terminal capability signaling. The network device may receive the first terminal capability signaling sent by the terminal, and the first terminal capability signaling may indicate that the terminal supports the first processing capability and does not support the second processing capability.

In step 1302, according to the first terminal capability signaling, it is determined that the terminal supports the first processing capability and does not support the second processing capability.

In some embodiments, based on the first terminal capability signaling, the network device may determine that the terminal supports the first processing capability and does not support the second processing capability. In some embodiments, the network device may configure the terminal processing capability of the terminal after determining the terminal processing capability supported by the terminal. The terminal may determine to enable a corresponding processing capability for data channel and/or signal processing through the configuration for the terminal processing capability by the network device.

By implementing the embodiment of the present disclosure, the support situation of the processing capability of the eRedCap terminal may be clarified by defining that three terminal processing capabilities (processing capability ½ and relaxed processing capability) exist in the NR system, and the first terminal capability signaling is sent to the network device by the terminal, to indicate to the network device that the terminal supports the first processing capability and does not support the second processing capability through the first terminal capability signaling, so that the network device may know the situation of the terminal processing capability supported by the terminal, and make configuration based on the situation of the terminal processing capability supported by the terminal, so as to support the relaxation of the processing capability of the eRedCap terminal.

Referring to FIG. 14, FIG. 14 is a flow chart of another method for determining a terminal processing capability provided by an embodiment of the present disclosure. It may be noted that the method for determining the terminal processing capability according to the embodiment of the present disclosure may be performed by a network device. As shown in FIG. 14, the method may include, but is not limited to, the following steps.

In step 1401, second terminal capability signaling sent by a terminal is received, and the second terminal capability signaling indicates that the terminal supports a first processing capability and a second processing capability.

In the embodiment of the present disclosure, the terminal may be an eRedCap terminal, and the terminal processing capability includes at least one of a first processing capability, a second processing capability and a third processing capability. The first processing capability is lower than the second processing capability, and the third processing capability is lower than the first processing capability.

In the embodiment of the present disclosure, the eRedCap terminal is a terminal configured to support the first processing capability, the second processing capability and the third processing capability. The first processing capability and the second processing capability are optional capabilities respectively, and the third processing capability is a default capability in which the terminal processing capability is not reported. In the embodiment of the present disclosure, the first processing capability and the second processing capability are optional capabilities and need to be reported through terminal processing signaling, and the third processing capability is the default capability and may not be reported through the terminal processing signaling.

In an implementation, for the eRedCap terminal, the reporting design of two optional capabilities (i.e., the first processing capability and the second processing capability) is as follows: in a case that the eRedCap terminal reports that it supports the second processing capability, it implicitly indicates to the network device that it supports the first processing capability, and the first processing capability does not need to be reported again.

In an embodiment of the present disclosure, in a case that the eRedCap terminal determines that it supports the first processing capability and the second processing capability, it may send the second terminal capability signaling to the network device, to report the processing capability in the second terminal capability signaling. The network device may receive the second terminal capability signaling sent by the terminal, and the second terminal capability signaling may indicate that the terminal supports the second processing capability, and may also implicitly indicate to the network device that the terminal supports the first processing capability, so that the first processing capability does not need to be reported again, thus saving signaling resources.

In step 1402, according to the second terminal capability signaling, it is determined that the terminal supports the first processing capability and the second processing capability.

In some embodiments, the network device may determine that the terminal supports the first processing capability and the second processing capability based on the second terminal capability signaling. In some embodiments, the network device may configure the terminal processing capability of the terminal after determining the terminal processing capability supported by the terminal. The terminal may determine to enable a corresponding processing capability for data channel and/or signal processing through the configuration for the terminal processing capability by the network device.

By implementing the embodiment of the present disclosure, the support situation of the processing capability of the eRedCap terminal is clarified by defining that three terminal processing capabilities (processing capability ½ and relaxed processing capability) exist in the NR system, and the second terminal capability signaling is sent to the network device by the terminal, to indicate to the network device that the terminal supports the second processing capability and implicitly indicate to the network device that the terminal supports the first processing capability, so that the first processing capability does not need to be reported again, thus saving signaling resources. In addition, the network device may know the situation of the terminal processing capability supported by the terminal through the second terminal capability signaling, and make configuration based on the situation of the terminal processing capability supported by the terminal, so as to support the relaxation of the processing capability of the eRedCap terminal.

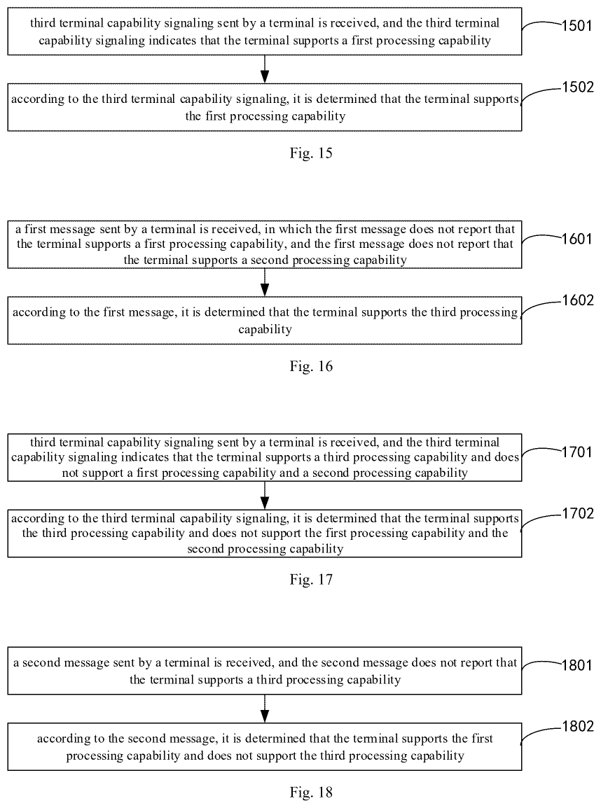

Referring to FIG. 15, FIG. 15 is a flow chart of another method for determining a terminal processing capability provided by an embodiment of the present disclosure. It may be noted that the method for determining the terminal processing capability according to the embodiment of the present disclosure may be performed by a network device. As shown in FIG. 15, the method may include, but is not limited to, the following steps:

In step 1501, third terminal capability signaling sent by a terminal is received, and the third terminal capability signaling indicates that the terminal supports a first processing capability.

In the embodiment of the present disclosure, the terminal may be an eRedCap terminal, and the terminal processing capability includes at least one of a first processing capability, a second processing capability and a third processing capability. The first processing capability is lower than the second processing capability and the third processing capability is lower than the first processing capability.

In the embodiment of the present disclosure, the eRedCap terminal is a terminal configured to support the first processing capability, the second processing capability and the third processing capability. The first processing capability and the second processing capability are optional capabilities respectively, and the third processing capability is a default capability in which the terminal processing capability is not reported. In the embodiment of the present disclosure, the first processing capability and the second processing capability are optional capabilities and need to be reported through terminal processing signaling, and the third processing capability is the default capability and may not be reported through the terminal processing signaling.

In an implementation, the eRedCap terminal may send the third terminal capability signaling to the network device, to report the processing capability in the third terminal capability signaling. The network device may receive the third terminal capability signaling sent by the terminal, and the third terminal capability signaling may indicate that the terminal supports the first processing capability.

In step 1502, according to the third terminal capability signaling, it is determined that the terminal supports the first processing capability.

In some embodiments, the network device may determine that the terminal supports the first processing capability based on the third terminal capability signaling. In some embodiments, the network device may configure the terminal processing capability of the terminal after determining the terminal processing capability supported by the terminal. The terminal may determine to enable a corresponding processing capability for data channel and/or signal processing through the configuration for the terminal processing capability by the network device.

By implementing the embodiment of the present disclosure, the support situation of the processing capability of the eRedCap terminal is clarified by defining that three terminal processing capabilities (processing capability ½ and relaxed processing capability) exist in the NR system, and the third terminal capability signaling is sent to the network device by the terminal, to indicate to the network device that the terminal supports the first processing capability through the third terminal capability signaling. In addition, through the third terminal capability signaling, the network device may know the situation of the terminal processing capability supported by the terminal, and make configuration based on the situation of the terminal processing capability supported by the terminal, so as to support the relaxation of the processing capability of the eRedCap terminal.

Referring to FIG. 16, FIG. 16 is a flow chart of another method for determining a terminal processing capability provided by an embodiment of the present disclosure. It may be noted that the method for determining the terminal processing capability according to the embodiment of the present disclosure may be performed by a network device. As shown in FIG. 16, the method may include, but is not limited to, the following steps.

In step 1601, a first message sent by a terminal is received, in which the first message does not report that the terminal supports a first processing capability, and the first message does not report that the terminal supports a second processing capability.

In the embodiment of the present disclosure, the terminal may be an eRedCap terminal, and the terminal processing capability includes at least one of a first processing capability, a second processing capability and a third processing capability. The first processing capability is lower than the second processing capability, and the third processing capability is lower than the first processing capability.

In the embodiment of the present disclosure, the eRedCap terminal is a terminal configured to support the first processing capability, the second processing capability and the third processing capability. The first processing capability and the second processing capability are optional capabilities respectively, and the third processing capability is a default capability in a case that the terminal processing capability is not reported. In the embodiment of the present disclosure, the first processing capability and the second processing capability are optional capabilities and need to be reported through terminal processing signaling, and the third processing capability is the default capability and may not be reported through the terminal processing signaling.

In an implementation, the eRedCap terminal may send the first message to the network device when determining the terminal processing capability supported by itself. The network device may receive the first message sent by the terminal, and since the first message does not report that the terminal supports the first processing capability and the first message does not report that the terminal supports the second processing capability, the first message may implicitly indicate to the network device that the terminal supports the third processing capability.

In step 1602, according to the first message, it is determined that the terminal supports the third processing capability.

In some embodiments, the network device may determine that the terminal supports the third processing capability according to the first message sent by the terminal. In some embodiments, the network device may configure the terminal processing capability of the terminal after determining the terminal processing capability supported by the terminal. The terminal may determine to enable a corresponding processing capability for data channel and/or signal processing through the configuration for the terminal processing capability by the network device.

By implementing the embodiment of the present disclosure, the support situation of the processing capability of the eRedCap terminal is clarified by defining that three terminal processing capabilities (processing capability ½ and relaxed processing capability) exist in the NR system, and the first message is sent to the network device by the terminal, to implicitly indicate to the network device that the terminal supports the third processing capability through the first message. In addition, through the first message, the network device may know the situation of the terminal processing capability supported by the terminal, and make configuration based on the situation of the terminal processing capability supported by the terminal, so as to support the relaxation of the processing capability of the eRedCap terminal.

Referring to FIG. 17, FIG. 17 is a flow chart of another method for determining a terminal processing capability provided by an embodiment of the present disclosure. It may be noted that the method for determining the terminal processing capability according to the embodiment of the present disclosure may be performed by a network device. As shown in FIG. 17, the method may include, but is not limited to, the following steps.

In step 1701, third terminal capability signaling sent by a terminal is received, and the third terminal capability signaling indicates that the terminal supports a third processing capability and does not support a first processing capability and a second processing capability.

In the embodiment of the present disclosure, the terminal may be an eRedCap terminal, and the terminal processing capability includes at least one of the first processing capability, the second processing capability and the third processing capability. The first processing capability is lower than the second processing capability, and the third processing capability is lower than the first processing capability.

In the embodiment of the present disclosure, the eRedCap terminal is a terminal configured to support the first processing capability, the second processing capability and the third processing capability. The second processing capability and the third processing capability are optional capabilities respectively, and the first processing capability is a default capability in a case that the terminal processing capability is not reported. In the embodiment of the present disclosure, the second processing capability and the third processing capability are optional capabilities and need to be reported through terminal processing signaling, and the first processing capability is the default capability and may not be reported through the terminal processing signaling.

In some embodiments of the present disclosure, the third processing capability may be separately reported for uplink transmission, downlink transmission and channel state information (CSI) calculation; or, the third processing capability may be combinatively reported for at least two of uplink transmission, downlink transmission and CSI calculation. That is, the uplink transmission, the downlink transmission and the channel state information (CSI) calculation may have separate terminal capability signaling for reporting the third processing capability. Alternatively, at least two of the uplink transmission, the downlink transmission and the channel state information (CSI) calculation may be combined for reporting the third processing capability. For example, the uplink transmission and the downlink transmission may use the same terminal capability signaling for reporting the third processing capability, or the uplink transmission and the CSI calculation may use the same terminal capability signaling for reporting the third processing capability, or the downlink transmission and the CSI calculation may use the same terminal capability signaling for reporting the third processing capability, or the uplink transmission, the downlink transmission and the CSI calculation may use the same terminal capability signaling for reporting the third processing capability.

In an implementation, in a case that the eRedCap terminal determines that it supports the third processing capability and does not support the first processing capability and the second processing capability, it may send the third terminal capability signaling to the network device, to report the processing capability in the third terminal capability signaling. The network device may receive the third terminal capability signaling sent by the terminal, and the third terminal capability signaling may indicate that the terminal supports the third processing capability and does not support the first processing capability and the second processing capability. In an implementation, in a case that one eRedCap terminal reports that it supports the third processing capability, it means that the first processing capability and the second processing capability are no longer supported.

In step 1702, according to the third terminal capability signaling, it is determined that the terminal supports the third processing capability and does not support the first processing capability and the second processing capability.

In some embodiments, the network device may determine that the terminal supports the third processing capability and does not support the first processing capability and the second processing capability based on the third terminal capability signaling. In some embodiments, the network device may configure the terminal processing capability of the terminal after determining the terminal processing capability supported by the terminal. The terminal may determine to enable a corresponding processing capability for data channel and/or signal processing through the configuration for the terminal processing capability by the network device.

By implementing the embodiment of the present disclosure, the support situation of the processing capability of the eRedCap terminal is clarified by defining that three terminal processing capabilities (processing capability ½ and relaxed processing capability) exist in the NR system, and the third terminal capability signaling is sent to the network device, to indicate to the network device that the terminal supports the third processing capability and does not support the first processing capability and the second processing capability through the third terminal capability signaling, so that the network device may know the situation of the terminal processing capability supported by the terminal, and make configuration based on the situation of the terminal processing capability supported by the terminal, so as to support the relaxation of the processing capability of the eRedCap terminal.

Referring to FIG. 18, FIG. 18 is a flow chart of another method for determining a terminal processing capability provided by an embodiment of the present disclosure. It may be noted that the method for determining the terminal processing capability according to the embodiment of the present disclosure may be performed by a network device. As shown in FIG. 18, the method may include, but is not limited to, the following steps.

In step 1801, a second message sent by a terminal is received, and the second message does not report that the terminal supports a third processing capability.

In the embodiment of the present disclosure, the terminal may be an eRedCap terminal, and the terminal processing capability includes at least one of a first processing capability, a second processing capability and a third processing capability. The first processing capability is lower than the second processing capability, and the third processing capability is lower than the first processing capability.

In the embodiment of the present disclosure, the eRedCap terminal is a terminal configured to support the first processing capability, the second processing capability and the third processing capability. The second processing capability and the third processing capability are optional capabilities respectively, and the first processing capability is a default capability in a case that the terminal processing capability is not reported. In the embodiment of the present disclosure, the second processing capability and the third processing capability are optional capabilities and need to be reported through terminal processing signaling, and the first processing capability is the default capability and may not be reported through the terminal processing signaling.

In some embodiments of the present disclosure, the third processing capability may be separately reported for uplink transmission, downlink transmission and channel state information (CSI) calculation; or, the third processing capability may be combinatively reported for at least two of uplink transmission, downlink transmission and CSI calculation. That is, the uplink transmission, the downlink transmission and the channel state information (CSI) calculation may have separate terminal capability signaling for reporting the third processing capability. Alternatively, at least two of the uplink transmission, the downlink transmission and the channel state information (CSI) calculation may be combined for reporting the third processing capability. For example, the uplink transmission and the downlink transmission may use the same terminal capability signaling for reporting the third processing capability, or the uplink transmission and the CSI calculation may use the same terminal capability signaling for reporting the third processing capability, or the downlink transmission and the CSI calculation may use the same terminal capability signaling for reporting the third processing capability, or the uplink transmission, the downlink transmission and the CSI calculation may use the same terminal capability signaling for reporting the third processing capability.

In an implementation, the eRedCap terminal may send the second message to the network device, the second message does not report that the third processing capability is supported. The network device may receive the second message sent by the terminal, and since the second message does not report that the third processing capability is supported, the network device may determine that the terminal supports the first processing capability and does not support the third processing capability through the second message. In an implementation, in a case that one eRedCap terminal does not report that the third processing capability is supported, it means that the terminal does not support the third processing capability.

In step 1802, according to the second message, it is determined that the terminal supports the first processing capability and does not support the third processing capability.

In some embodiments, since the second message does not report that the third processing capability is supported, it may be implicitly indicated that the terminal supports the first processing capability and does not support the third processing capability. Thus, when the network device receives the second message sent by the terminal, the network device may determine that the terminal supports the first processing capability and does not support the third processing capability according to the second message. In some embodiments, the network device may configure the terminal processing capability of the terminal after determining the terminal processing capability supported by the terminal. The terminal may determine to enable a corresponding processing capability for data channel and/or signal processing through the configuration for the terminal processing capability by the network device.

By implementing the embodiment of the present disclosure, the support situation of the processing capability of the eRedCap terminal is clarified by defining that three terminal processing capabilities (processing capability ½ and relaxed processing capability) exist in the NR system, and the second message is sent to the network device by the terminal, to implicitly indicates to the network device that the terminal supports the first processing capability and does not support the third processing capability through the second message, so that the network device may know the situation of the terminal processing capability supported by the terminal, and make configuration based on the situation of the terminal processing capability supported by the terminal, so as to support the relaxation of the processing capability of the eRedCap terminal.

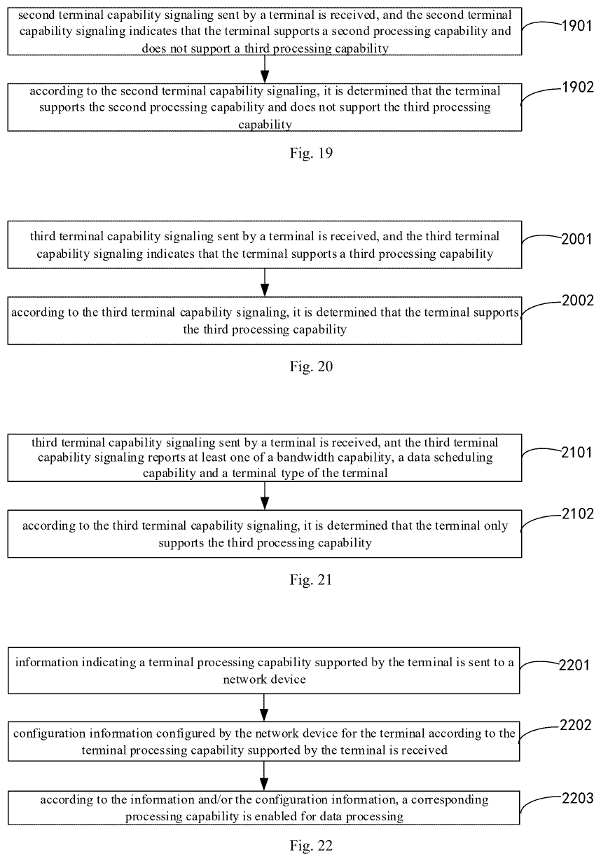

Referring to FIG. 19, FIG. 19 is a flow chart of another method for determining a terminal processing capability provided by an embodiment of the present disclosure. It may be noted that the method for determining the terminal processing capability according to the embodiment of the present disclosure may be performed by a network device. As shown in FIG. 19, the method may include, but is not limited to, the following steps.

In step 1901, second terminal capability signaling sent by a terminal is received, and the second terminal capability signaling indicates that the terminal supports a second processing capability and does not support a third processing capability.

In the embodiment of the present disclosure, the terminal may be an eRedCap terminal, and the terminal processing capability includes at least one of a first processing capability, a second processing capability and a third processing capability. The first processing capability is lower than the second processing capability, and the third processing capability is lower than the first processing capability.

In the embodiment of the present disclosure, the eRedCap terminal is a terminal configured to support the first processing capability, the second processing capability and the third processing capability. The second processing capability and the third processing capability are optional capabilities respectively, and the first processing capability is a default capability in a case that the terminal processing capability is not reported. In the embodiment of the present disclosure, the second processing capability and the third processing capability are optional capabilities and need to be reported through terminal processing signaling, and the first processing capability is the default capability and may not be reported through the terminal processing signaling.

In an implementation, the second processing capability and the third processing capability cannot be reported simultaneously. In an embodiment of the present disclosure, the eRedCap terminal may send the second terminal capability signaling to the network device, to report the processing capability in the second terminal capability signaling. The network device may receive the second terminal capability signaling sent by the terminal, and the second terminal capability signaling indicates that the terminal supports the second processing capability and does not support the third processing capability.

In step 1902, according to the second terminal capability signaling, it is determined that the terminal supports the second processing capability and does not support the third processing capability.

In some embodiments, the network device may determine that the terminal supports the second processing capability and does not support the third processing capability based on the second terminal capability signaling. In some embodiments, the network device may configure the terminal processing capability of the terminal after determining the terminal processing capability supported by the terminal. The terminal may determine to enable a corresponding processing capability for data channel and/or signal processing through the configuration for the terminal processing capability by the network device.

By implementing the embodiment of the present disclosure, the support situation of the processing capability of the eRedCap terminal is clarified by defining that three terminal processing capabilities (processing capability ½ and relaxed processing capability) exist in the NR system, and the second terminal capability signaling is sent to the network device by the terminal, to indicate to the network device that the terminal supports the second processing capability and does not support the third processing capability through the second terminal capability signaling, so that the network device may know the situation of the terminal processing capability supported by the terminal, and make configuration based on the situation of the terminal processing capability supported by the terminal, so as to support the relaxation of the processing capability of the eRedCap terminal.

Referring to FIG. 20, FIG. 20 is a flow chart of another method for determining a terminal processing capability provided by an embodiment of the present disclosure. It may be noted that the method for determining the terminal processing capability according to the embodiment of the present disclosure may be performed by a network device. As shown in FIG. 20, the method may include, but is not limited to, the following steps.

In step 2001, third terminal capability signaling sent by a terminal is received, and the third terminal capability signaling indicates that the terminal supports a third processing capability.

In the embodiment of the present disclosure, the terminal may be an eRedCap terminal, and the terminal processing capability includes at least one of a first processing capability, a second processing capability and a third processing capability. The first processing capability is lower than the second processing capability, and the third processing capability is lower than the first processing capability.

In the embodiment of the present disclosure, the eRedCap terminal is a terminal configured to support the first processing capability, the second processing capability and the third processing capability. The second processing capability and the third processing capability are optional capabilities respectively, and the first processing capability is a default capability in a case that the terminal processing capability is not reported. In the embodiment of the present disclosure, the second processing capability and the third processing capability are optional capabilities and need to be reported through terminal processing signaling, and the first processing capability is the default capability and may not be reported through the terminal processing signaling.

In an implementation, the eRedCap terminal may send the third terminal capability signaling to the network device, to report the processing capability in the third terminal capability signaling. The network device may receive the third terminal capability signaling sent by the terminal, and the third terminal capability signaling indicates that the terminal supports the third processing capability.

In step 2002, according to the third terminal capability signaling, it is determined that the terminal supports the third processing capability.

In some embodiments, the network device may determine that the terminal supports the third processing capability based on the third terminal capability signaling. In some embodiments, the network device may configure the terminal processing capability of the terminal after determining the terminal processing capability supported by the terminal. The terminal may determine to enable a corresponding processing capability for data channel and/or signal processing through the configuration for the terminal processing capability by the network device.

By implementing the embodiment of the present disclosure, the support situation of the processing capability of the eRedCap terminal is clarified by defining that three terminal processing capabilities (processing capability ½ and relaxed processing capability) exist in the NR system, and the third terminal capability signaling is sent to the network device by the terminal, to indicate to the network device that the terminal supports the third processing capability through the third terminal capability signaling, so that the network device may know the situation of the terminal processing capability supported by the terminal, and make configuration based on the situation of the terminal processing capability supported by the terminal, so as to support the relaxation of the processing capability of the eRedCap terminal.

It may be noted that all the eRedCap terminals in the NR system only support the third processing capability. In an implementation, the eRedCap terminal is a terminal that only supports the third processing capability. In an embodiment of the present disclosure, all of uplink transmission, downlink transmission and CSI calculation may only support the third processing capability.

Referring to FIG. 21, FIG. 21 is a flow chart of another method for determining a terminal processing capability provided by an embodiment of the present disclosure. It may be noted that the method for determining the terminal processing capability according to the embodiment of the present disclosure may be performed by a network device. As shown in FIG. 21, the method may include, but is not limited to, the following steps.

In step 2101, third terminal capability signaling sent by a terminal is received, ant the third terminal capability signaling reports at least one of a bandwidth capability, a data scheduling capability and a terminal type of the terminal.

In the embodiment of the present disclosure, the terminal may be an eRedCap terminal, and the terminal processing capability includes at least one of a first processing capability, a second processing capability and a third processing capability. The first processing capability is lower than the second processing capability, and the third processing capability is lower than the first processing capability.

In the embodiment of the present disclosure, the eRedCap terminal is a terminal that only supports the third processing capability.

In an implementation, the eRedCap terminal does not need to report the terminal processing capability in the terminal capability signaling, and the eRedCap terminal may report its bandwidth capability and/or data scheduling capability and/or terminal type in the terminal (e.g., UE) capability signaling, which implicitly indicates that the terminal only supports the third processing capability. In an embodiment of the present disclosure, the eRedCap terminal may send the third terminal capability signaling to the network device when determining that it only supports the third processing capability, to report at least one of the bandwidth capability, the data scheduling capability and the terminal type of the terminal in the third terminal capability signaling. The network device may receive the third terminal capability signaling sent by the terminal, and the third terminal capability signaling may implicitly indicate that the terminal only supports the third processing capability.

In step 2102, according to the third terminal capability signaling, it is determined that the terminal only supports the third processing capability.

In some embodiments, the network device may determine that the terminal only supports the third processing capability based on the third terminal capability signaling. In some embodiments, in a case that the network device determines that the terminal only supports the third processing capability, the network device may always schedule the terminal based on the third processing capability. The terminal also performs data channel/signal processing based on the third processing capability.

By implementing the embodiment of the present disclosure, the support situation of the processing capability of the eRedCap terminal is clarified by defining that three terminal processing capabilities (processing capability ½ and relaxed processing capability) exist in the NR system, and the third terminal capability signaling is sent to the network device by the terminal, to implicitly indicate to the network device that the terminal only supports the third processing capability through the third terminal capability signaling, so that the network device may know the situation of the terminal processing capability supported by the terminal, and make configuration based on the situation of the terminal processing capability supported by the terminal, so as to support the relaxation of the processing capability of the eRedCap terminal.

An embodiment of the present disclosure provides a data processing method. The terminal may send the information to the network device to inform the network device of the terminal processing capability supported by the terminal. After the network device determines the terminal processing capability supported by the terminal according to the information sent by the terminal, it may configure the processing capability of the terminal. The terminal may determine to enable a corresponding processing capability for data processing according to the terminal processing capability supported by itself and the configuration for the processing capability by the network device. Referring to FIG. 22, FIG. 22 is a flow chart of a data processing method provided by an embodiment of the present disclosure. It may be noted that the data processing method according to the embodiment of the present disclosure may be performed by a terminal. As shown in FIG. 22, the method may include, but is not limited to, the following steps.

In step 2201, information indicating a terminal processing capability supported by the terminal is sent to a network device.

In the embodiment of the present disclosure, the terminal may be an eRedCap terminal, and the terminal processing capability includes at least one of a first processing capability, a second processing capability and a third processing capability. The first processing capability is lower than the second processing capability, and the third processing capability is lower than the first processing capability.

In the embodiment of the present disclosure, step 2201 may be realized by any one of the embodiments of the present disclosure, which is not limited in the embodiment of the present disclosure, and will not be repeated here.

In step 2202, configuration information configured by the network device for the terminal according to the terminal processing capability supported by the terminal is received.

In some embodiments, the terminal may send the information to the network device to inform the network device of the terminal processing capability supported by the terminal. After the network device determines the terminal processing capability supported by the terminal according to the information sent by the terminal, it may configure the processing capability of the terminal and send the configuration information to the terminal. The terminal may receive the configuration information sent by the network device, and the configuration information is configuration information configured by the network device for the terminal processing capability of the terminal.

In step 2203, according to the information and/or the configuration information, a corresponding processing capability is enabled for data processing.

In some embodiments, the terminal may enable the corresponding processing capability for data channel/signal processing according to the information and/or the configuration information.

It may be noted that there may be eRedCap terminals in the NR system, that support the above three terminal processing capabilities, such as the first processing capability, the second processing capability and the third processing capability. In an implementation, the eRedCap terminal is a terminal configured to support the first processing capability, the second processing capability and the third processing capability, in which the first processing capability and the second processing capability are optional capabilities respectively, and the third processing capability is the default capability in a case that the terminal processing capability is not reported. Since the optional capabilities and the default capabilities supported by the eRedCap terminals are different, the methods for reporting the terminal processing capability are different, so that the configuration for the processing capabilities of the terminals by the network device is different, and thus the terminals have different processing capabilities for data processing. Various implementation methods for the terminal to enable the corresponding processing capability for data processing will be described with reference to the embodiments in the following.

In some embodiments of the present disclosure, the eRedCap terminal is the terminal configured to support the first processing capability, the second processing capability and the third processing capability. The first processing capability and the second processing capability are optional capabilities respectively, and the third processing capability is the default capability in a case that the terminal processing capability is not reported.

In an embodiment of the present disclosure, an implementation method of enabling the corresponding processing capability for data processing according to the information and/or the configuration information may include: enabling the first processing capability for data processing by default, or enabling the first processing capability for data processing according to the configuration information, in a case that it is determined according to the information that the terminal reports supporting the second processing capability, and it is determined according to the configuration information that the network device does not configure the second processing capability or sets the second processing capability as disabled.

In some embodiments, for one eRedCap terminal, in a case that it is reported that the first processing capability and/or the second processing capability are supported, the third processing capability may no longer be supported (considering that since the first processing capability and/or the second processing capability are supported, the cost of the terminal will no longer be reduced, and in a case that the terminal is scheduled still according to the third processing capability, only additional scheduling time will be introduced). In this case, when the terminal reports supporting the second processing capability and the second processing capability is not configured or is disabled, the terminal may enable the first processing capability by default, and directly use the first processing capability for data channel/signal processing by default without radio resource control (RRC) signaling configuration.

In some embodiments, in a case that the terminal reports supporting the second processing capability and the second processing capability is not configured or is disabled, the terminal may determine to enable the first processing capability for data channel/signal processing according to the configuration information of the network device. That is, the network device needs to configure the first processing capability through RRC signaling, and the first processing capability needs to be forcibly configured to be available.

In an embodiment of the present disclosure, an implementation method of enabling the corresponding processing capability for data processing according to the information and/or the configuration information may include: enabling the first processing capability for data processing by default, or enabling the first processing capability for data processing according to the configuration information, in a case that it is determined according to the information that the terminal does not report supporting the second processing capability, and it is determined according to the information that the terminal reports supporting the first processing capability.

In some embodiments, for one eRedCap terminal, in a case that it is reported that the first processing capability and/or the second processing capability are supported, the third processing capability may no longer be supported (considering that since the first processing capability and/or the second processing capability are supported, the cost of the terminal will no longer be reduced, and in a case that the terminal is scheduled still according to the third processing capability, only additional scheduling time will be introduced). In this case, when the terminal does not report supporting the second processing capability and reports supporting the first processing capability, the terminal may enable the first processing capability for data channel/signal processing by default. That is, in this case, the network device does not need to configure the first processing capability through RRC signaling, and both the terminal and the network device enable the first processing capability for data processing by default.

In some embodiments, in a case that the terminal does not report supporting the second processing capability and reports supporting the first processing capability, the terminal may enable the first processing capability for data processing according to the configuration information sent by the network device. That is, in this case, the network device always configures and enables the first processing capability for data processing.

In an embodiment of the present disclosure, an implementation method of enabling the corresponding processing capability for data processing according to the information and/or the configuration information may include: enabling the first processing capability for data processing by default or enabling the first processing capability for data processing according to the configuration information, in a case that it is determined according to the information that the terminal reports supporting the first processing capability.

In some embodiments, for one eRedCap terminal, in a case that it is reported that the first processing capability and/or the second processing capability are supported, the third processing capability may no longer be supported (considering that since the first processing capability and/or the second processing capability are supported, the cost of the terminal will no longer be reduced, and in a case that the terminal is scheduled still according to the third processing capability, only additional scheduling time will be introduced). In this case, when the terminal reports supporting the first processing capability, the terminal may enable the first processing capability for data processing by default.

In some embodiments, in a case that the terminal reports supporting the first processing capability, the terminal may determine to enable the first processing capability for data channel/signal processing according to the configuration for the first processing capability by the network device.

In an embodiment of the present disclosure, an implementation method of enabling the corresponding processing capability for data processing according to the information and/or the configuration information may include: enabling the first processing capability for data processing in a case that it is determined according to the information that the terminal reports supporting the first processing capability, and it is determined according to the configuration information that the network device configures the first processing capability; or, enabling the third processing capability for data processing, in a case that it is determined according to the information that the terminal reports supporting the first processing capability, and it is determined according to the configuration information that the network device does not configure the first processing capability or configures the first processing capability as disabled.

It may be noted that in some embodiments of the present application, enabling RRC signaling may be added for the first processing capability (UE processing capability 1), such as processingType1Enabled, and the network device may configure the first processing capability through the added enabling RRC signaling.

In some embodiments, in a case that the terminal reports supporting the first processing capability, and the network device does not configure the first processing capability or configures the first processing capability as disabled, the terminal enables the third processing capability for data processing.

In an embodiment of the present disclosure, an implementation method of enabling the corresponding processing capability for data processing according to the information and/or the configuration information may include: enabling the second processing capability for data processing, in a case that it is determined according to the information that the terminal reports supporting the second processing capability, and it is determined according to the configuration information that the network device configures the second processing capability; or, enabling the first processing capability for data processing, in a case that it is determined according to the information that the terminal reports supporting the second processing capability, and it is determined according to the configuration information that the network device does not configure the second processing capability or sets the second processing capability as disabled; or, enabling the third processing capability for data processing, in a case that it is determined according to the information that the terminal reports supporting the first processing capability, and it is determined according to the configuration information that the network device sets the first processing capability as disabled.

As a possible implementation, considering from other perspectives, for example, from the perspective of reducing the energy consumption of the terminal, the third processing capability is also supported, and the first processing capability and/or the second processing capability may retreat to the third processing capability, that is, the capability retreats to the lowest capability. In some embodiments, based on this situation, the enabling RRC signaling may be added for the first processing capability (UE processing capability 1), such as processingType1Enabled. In a case that this field is not configured, the following explanation may be made: in a case that the terminal reports supporting the second processing capability and the network device configures the second processing capability, the terminal enables the second processing for data processing. In some embodiments, in a case that the terminal reports supporting the second processing capability and the network device does not configure the second processing capability (or sets the second processing capability as disabled), the terminal enables the first processing capability. In some embodiments, the terminal enables the third processing capability for data processing only in a case that the field in the enabling RRC signaling of the first processing capability (UE processing capability 1) is configured as disabled.

In an embodiment of the present disclosure, an implementation method of enabling the corresponding processing capability for data processing according to the information and/or the configuration information may include: enabling the second processing capability for data processing in a case that it is determined according to the information that the terminal reports supporting the second processing capability, and it is determined according to the configuration information that the network device configures the second processing capability; or, enabling the third processing capability for data processing, in a case that it is determined according to the information that the terminal reports supporting the second processing capability, and it is determined according to the configuration information that the network device does not configure the second processing capability or sets the second processing capability as disabled.

As a possible implementation, considering from other perspectives, for example, from the perspective of reducing the energy consumption of the terminal, the third processing capability is also supported, and the first processing capability and/or the second processing capability may retreat to the third processing capability. In some embodiments, based on this situation, the enabling RRC signaling may be added for the first processing capability (UE processing capability 1), such as processingType1Enabled. In a case that this field is not configured, the following explanation may be made: in a case that the terminal reports supporting the second processing capability and the network device configures the second processing capability, the terminal enables the second processing capability for data processing. In some embodiments, in a case that the terminal reports supporting the second processing capability and the network device does not configure the second processing capability (or sets the second processing capability as disabled), the terminal enables the third processing capability for data channel/signal processing.

In an embodiment of the present disclosure, an implementation method of enabling the corresponding processing capability for data processing according to the information and/or the configuration information may include: enabling the second processing capability for data processing in a case that it is determined according to the information that the terminal reports supporting the first processing capability, and it is determined according to the configuration information that the network device configures the second processing capability; or, enabling the first processing capability for data processing by default, in a case that it is determined according to the information that the terminal reports supporting the first processing capability, and it is determined according to the configuration information that the network device does not configure the second processing capability or the second processing capability is set as disabled; or, enabling the first processing capability for data processing according to the configuration information, in a case that it is determined according to the information that the terminal reports supporting the first processing capability, and it is determined according to the configuration information that the network device does not configure the second processing capability or the second processing capability is set as disabled; or, enabling the third processing capability for data processing by default, in a case that it is determined according to the configuration information that the network device does not configure the first processing capability and the second processing capability or the first processing capability and the second processing capability are set as disabled.

In the embodiment of the present disclosure, in a case that the terminal reports not supporting the first processing capability and reports not supporting the second processing capability, the terminal enables the third processing capability for data channel/signal processing by default.

It may be noted that there may be the eRedCap terminals in the NR system, that support the above three terminal processing capabilities, such as the first processing capability, the second processing capability and the third processing capability. In an implementation, the eRedCap terminal is a terminal configured to support the first processing capability, the second processing capability and the third processing capability. The second processing capability and the third processing capability are optional capabilities respectively, and the first processing capability is a default capability in a case that the terminal processing capability is not reported. Since the optional capabilities and the default capabilities supported by the eRedCap terminals are different, the methods for reporting the terminal processing capability are different, so that the configuration for the processing capabilities of the terminals by the network devices is different, and thus the terminals have different processing capabilities for data processing. Various implementation methods for the terminal to enable the corresponding processing capability for data processing will be described with reference to the embodiments in the following.

In an embodiment of the present disclosure, an implementation method of enabling the corresponding processing capability for data processing according to the information and/or the configuration information may include: in a case that it is determined according to the information that the terminal reports supporting the third processing capability, and it is determined according to the configuration information that the network device does not configure the third processing capability or set the third processing capability as enabled, the terminal may enable the first processing capability for data processing by default.

That is, in a case that the terminal reports supporting the third processing capability, it means that the terminal only supports the third processing capability, and the network device does not need to make capability configuration, the terminal may enable the third processing capability for data processing by default, and the network device uses the third processing capability for data scheduling and processing by default. Alternatively, in a case that the terminal reports supporting the third processing capability, it means that the terminal only supports the third processing capability, the network device may make configuration through signaling, such as setting the third processing capability as enabled, and the terminal enables the third processing capability for data processing.

It may be noted that in a case that the terminal reports supporting the third processing capability and the network device does not configure the third processing capability, it may retreat to the first processing capability for data processing.

In an embodiment of the present disclosure, an implementation method of enabling the corresponding processing capability for data processing according to the information and/or the configuration information may include: the terminal may enable any one of the first processing capability, the second processing capability and the third processing capability for data processing, in a case that that it is determined according to the information that the terminal reports the second processing capability and the third processing capability simultaneously.

In an embodiment of the present disclosure, an implementation method of enabling the corresponding processing capability for data processing according to the information and/or the configuration information may include: in a case that it is determined according to the information that the terminal does not report the third processing capability, and it is determined according to the information that the terminal reports the second processing capability, the terminal may enable the corresponding processing capability for data processing according to the configuration information; or, in a case that it is determined according to the information that the terminal does not report the third processing capability, and it is determined according to the information that the terminal does not report the second processing capability, the terminal enables the first processing capability for data processing by default.

In some embodiments, in a case that the terminal does not report the third processing capability, the first processing capability is supported by default, and then according to whether the second processing capability is reported and the configuration by the network device, it is finally determined which processing capability is enabled for data channel/signal processing.

In an embodiment of the present disclosure, in a case that it is determined according to the information that the terminal reports supporting the third processing capability, the terminal may always enable the third processing capability for data processing by default. In some embodiments, there is no need to configure separate enabling signaling for the third processing capability of the eRedCap terminal. In a case that one terminal reports supporting the third processing capability, the terminal may always enable the third processing capability by default. In some embodiments, in a case that the terminal does not report supporting the third processing capability, the terminal may determine to enable the first processing capability or the second processing capability for data processing according to the configuration information sent by the network device.

In some embodiments of the present disclosure, the above configuration information may be separately configured for uplink transmission, downlink transmission and channel state information (CSI) calculation; or, the above configuration information may be combinatively configured for at least two of uplink transmission, downlink transmission and CSI calculation. That is, the uplink transmission, the downlink transmission and the channel state information (CSI) calculation may have separate configuration signaling for configuring the processing capability. Alternatively, at least two of the uplink transmission, the downlink transmission and the channel state information (CSI) calculation may be combined for configuring the processing capability. For example, the uplink transmission and the downlink transmission may use the same configuration signaling for configuring the processing capability, or the uplink transmission and the CSI calculation may use the same configuration signaling for configuring the processing capability, or the downlink transmission and the CSI calculation may use the same configuration signaling for configuring the processing capability, or the uplink transmission, the downlink transmission and the CSI calculation may use the same configuration signaling for configuring the processing capability.

It may be noted that all the eRedCap terminals in the NR system only support the third processing capability. In an implementation, the eRedCap terminal is a terminal that only supports the third processing capability. In an embodiment of the present disclosure, all of the uplink transmission, the downlink transmission and the CSI calculation may only support the third processing capability. In the embodiment of the present disclosure, the terminal may enable the third processing capability for data processing. That is, in a case that the terminal reports supporting the third processing capability, it means that the terminal only supports the third processing capability, the network device does not need to make capability configuration, the terminal may enable the third processing capability for data processing by default, and the network device uses the third processing capability for data scheduling and processing by default. Alternatively, in a case that the terminal reports supporting the third processing capability, it means that the terminal only supports the third processing capability, and the network device may make configuration through signaling, such as setting the third processing capability as enabled, and the terminal enables the third processing capability for data processing.

By implementing the embodiment of the present disclosure, the support situation of the processing capability of the eRedCap terminal is clarified by defining that three terminal processing capabilities (processing capability ½ and relaxed processing capability) exist in the NR system, and the information indicating the terminal processing capability supported by the terminal is sent to the network device by the terminal, so that the network device configures the processing capability of the terminal based on the information, and the terminal determines to enable the corresponding processing capability for data processing according to the information and/or the configuration information, so as to support the relaxation of the processing capability of the eRedCap terminal.

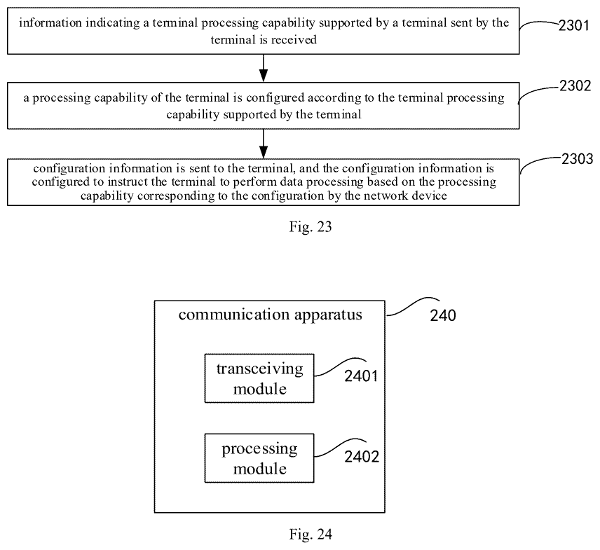

It may be understood that the above embodiment describes the implementation of the data processing method of the embodiment of the present disclosure from a terminal side. An embodiment of the present disclosure also provides another data processing method, and the implementation of this data processing method will be described from a network device below. Referring to FIG. 23, FIG. 23 is a flow chart of another data processing method provided by an embodiment of the present disclosure. It may be noted that the data processing method according to the embodiment of the present disclosure may be performed by a network device. As shown in FIG. 23, the method may include, but is not limited to, the following steps.

In step 2301, information indicating a terminal processing capability supported by a terminal sent by the terminal is received.

In the embodiment of the present disclosure, the terminal is an eRedCap terminal, and the terminal processing capability includes at least one of a first processing capability, a second processing capability and a third processing capability. The first processing capability is lower than the second processing capability, and the third processing capability is lower than the first processing capability.

In the embodiment of the present disclosure, step 2301 may be realized in any one of the embodiments of the present disclosure, which is not limited in the embodiment of the present disclosure and will not be repeated here.

In step 2302, a processing capability of the terminal is configured according to the terminal processing capability supported by the terminal.

In step 2303, configuration information is sent to the terminal, and the configuration information is configured to instruct the terminal to perform data processing based on the processing capability corresponding to the configuration by the network device.

In some embodiments, after the network device determines the terminal processing capability supported by the terminal according to the information sent by the terminal, it may configure the processing capability of the terminal and send the configuration information to the terminal. The terminal may receive the configuration information sent by the network device. The configuration information is configuration information configured by the network device for the terminal processing capability of the terminal. The terminal may enable the corresponding processing capability for data channel/signal processing according to the information and/or the configuration information.

In the embodiment of the present disclosure, step 2303 may be realized in any one of the embodiments of the present disclosure, which is not limited in the embodiment of the present disclosure and will not be repeated here.

It may be noted that all the eRedCap terminals in the NR system only support the third processing capability. In an implementation, the eRedCap terminal is a terminal that only supports the third processing capability. In an embodiment of the present disclosure, all of uplink transmission, downlink transmission and CSI calculation may only support the third processing capability. In the embodiment of the present disclosure, the network device may always schedule the eRedCap terminal based on the third processing capability.

By implementing the embodiment of the present disclosure, the support situation of the processing capability of the eRedCap terminal is clarified by defining that three terminal processing capabilities (processing capability ½ and relaxed processing capability) exist in the NR system, and the information indicating the terminal processing capability supported by the terminal is sent to the network device by the terminal, so that the network device configures the processing capability of the terminal based on the information, and the terminal determines to enable the corresponding processing capability for data processing according to the information and/or the configuration information, so as to support the relaxation of the processing capability of the eRedCap terminal.

In the above embodiments provided by the present disclosure, the methods provided by the embodiments of the present disclosure are introduced from the perspectives of the network device and the terminal respectively. In order to realize the functions in the methods provided by the embodiments of the present disclosure, the network device and the terminal may include hardware structures and software modules, and the above functions are realized in the form of hardware structures, software modules, or hardware structures plus software modules. A certain one of the above functions may be implemented in the form of the hardware structure, the software module, or the hardware structure plus the software module.

Referring to FIG. 24, FIG. 24 is a schematic diagram of a communication apparatus 240 provided by an embodiment of the present disclosure. The communication apparatus 240 shown in FIG. 24 may include a transceiving module 2401 and a processing module 2402. The transceiving module 2401 may include a sending module and/or a receiving module. The sending module is used for realizing a sending function and the receiving module is used for realizing a receiving function. The transceiving module 2401 may realize the sending function and/or the receiving function.

The communication apparatus 240 may be a terminal, an apparatus in the terminal, or an apparatus that may be used in conjunction with the terminal. Alternatively, the communication apparatus 240 may be a network device, an apparatus in the network device, or an apparatus that may be used in conjunction with the network device.

The communication apparatus 240 is the terminal.

For a scheme that the communication apparatus 240 executes the above method for reporting the terminal processing capability, in an embodiment of the present disclosure, the communication apparatus 240 may include a processing module 2402 and a transceiving module 2401. The processing module 2402 is configured to determine the terminal processing capability supported by the terminal; and the transceiving module 2401 is configured to send information indicating the terminal processing capability supported by the terminal to a network device. The terminal is an eRedCap terminal, and the terminal processing capability includes at least one of a first processing capability, a second processing capability and a third processing capability. The first processing capability is lower than the second processing capability, and the third processing capability is lower than the first processing capability.

In the embodiment of the present disclosure, the eRedCap terminal is a terminal configured to support the first processing capability, the second processing capability and the third processing capability. The first processing capability and the second processing capability are optional capabilities respectively, and the third processing capability is a default capability in a case that the terminal processing capability is not reported.

In an implementation, the transceiving module 2401 may send first terminal capability signaling to the network device, and the first terminal capability signaling indicates that the terminal supports the first processing capability and does not support the second processing capability.

In an implementation, the transceiving module 2401 may send second terminal capability signaling to the network device, and the second terminal capability signaling indicates that the terminal supports the first processing capability and the second processing capability.

In an implementation, the transceiving module 2401 may send third terminal capability signaling to the network device, and the third terminal capability signaling indicates that the terminal supports the first processing capability.

In an implementation, the transceiving module 2401 may send a first message to the network device. The first message does not report that the terminal supports the first processing capability and the first message does not report that the terminal supports the second processing capability, and the first message implicitly indicates to the network device that the terminal supports the third processing capability.

In some embodiments, the first processing capability is separately reported for uplink transmission, downlink transmission and CSI calculation; or, the first processing capability is combinatively reported for at least two of uplink transmission, downlink transmission and CSI calculation.

In an embodiment of the present disclosure, the eRedCap terminal is a terminal configured to support the first processing capability, the second processing capability and the third processing capability. The second processing capability and the third processing capability are optional capabilities respectively, and the first processing capability is a default capability in a case that the terminal processing capability is not reported.

In an implementation, the transceiving module 2401 may send third terminal capability signaling to the network device, and the third terminal capability signaling indicates that the terminal supports the third processing capability and does not support the first processing capability and the second processing capability.

In an implementation, the transceiving module 2401 may send a second message to a network device. The second message does not report that the terminal supports the third processing capability, and the second message implicitly indicates to the network device that the terminal supports the first processing capability and does not support the third processing capability.

In an implementation, the transceiving module 2401 may send second terminal capability signaling to the network device, and the second terminal capability signaling indicates that the terminal supports the second processing capability and does not support the third processing capability.

In an implementation, the transceiving module 2401 may send third terminal capability signaling to the network device, and the third terminal capability signaling indicates that the terminal supports the third processing capability.

In some embodiments, the third processing capability is separately reported for uplink transmission, downlink transmission and CSI calculation; or, the third processing capability is combinatively reported for at least two of uplink transmission, downlink transmission and CSI calculation.

In an embodiment of the present disclosure, the eRedCap terminal is a terminal that only supports the third processing capability. In an implementation, the transceiving module 2401 may send third terminal capability signaling to the network device. The third terminal capability signaling reports at least one of a bandwidth capability, a data scheduling capability and a terminal type of the terminal, and implicitly indicates to the network device that the terminal only supports the third processing capability.

For a scheme that the communication apparatus 240 executes the above data processing method, in an embodiment of the present disclosure, the communication apparatus 240 may include a processing module 2402 and a transceiving module 2401. The transceiving module 2401 is configured to send information indicating a terminal processing capability supported by a terminal to a network device; the transceiving module 2401 is further configured to receive configuration information configured by the network device for the terminal according to the terminal processing capability supported by the terminal; and the processing module 2402 is configured to enable a corresponding processing capability for data processing according to the information and/or the configuration information. The terminal is an eRedCap terminal, and the terminal processing capability includes at least one of a first processing capability, a second processing capability and a third processing capability. The first processing capability is lower than the second processing capability, and the third processing capability is lower than the first processing capability.

In an embodiment of the present disclosure, the eRedCap terminal is a terminal configured to support the first processing capability, the second processing capability and the third processing capability. The first processing capability and the second processing capability are optional capabilities respectively, and the third processing capability is a default capability in a case that the terminal processing capability is not reported.

In an implementation, the processing module 2402 is specifically configured to enable the first processing capability for data processing by default, or to enable the first processing capability for data processing according to the configuration information, in a case that it is determined according to the information that the terminal reports supporting the second processing capability, and it is determined according to the configuration information that the network device does not configure the second processing capability or sets the second processing capability as disabled.

In an implementation, the processing module 2402 is specifically configured to enable the first processing capability for data processing by default, or enable the first processing capability for data processing according to the configuration information, in a case that it is determined according to the information that the terminal does not report supporting the second processing capability, and it is determined according to the information that the terminal reports supporting the first processing capability.

In an implementation, the processing module 2402 is specifically configured to enable the first processing capability for data processing by default, or to enable the first processing capability for data processing according to the configuration information, in a case that it is determined according to the information that the terminal reports supporting the first processing capability.

In an implementation, the processing module 2402 is specifically configured to: enable the first processing capability for data processing, in a case that it is determined according to the information that the terminal reports supporting the first processing capability, and it is determined according to the configuration information that the network device configures the first processing capability; or, enable the third processing capability for data processing, in a case that it is determined according to the information that the terminal reports supporting the first processing capability, and it is determined according to the configuration information that the network device does not configure the first processing capability or configures the first processing capability as disabled.

In an implementation, the processing module 2402 is specifically configured to: enable the second processing capability for data processing, in a case that it is determined according to the information that the terminal reports supporting the second processing capability, and it is determined according to the configuration information that the network device configures the second processing capability; or, enable the first processing capability for data processing, in a case that it is determined according to the information that the terminal reports supporting the second processing capability, and it is determined according to the configuration information that the network device does not configure the second processing capability or sets the second processing capability as disabled; or, enable the third processing capability for data processing, in a case that it is determined according to the information that the terminal reports supporting the first processing capability, and it is determined according to the configuration information that the network device sets the first processing capability as disabled.

In an implementation, the processing module 2402 is specifically configured to: enable the second processing capability for data processing, in a case that it is determined according to the information that the terminal reports supporting the second processing capability, and it is determined according to the configuration information that the network device configures the second processing capability; or, enable the third processing capability for data processing, in a case that it is determined according to the information that the terminal reports supporting the second processing capability, and it is determined according to the configuration information that the network device does not configure the second processing capability or sets the second processing capability as disabled.

In an implementation, the processing module 2402 is specifically configured to: enable the second processing capability for data processing, in a case that it is determined according to the information that the terminal reports supporting the first processing capability, and it is determined according to the configuration information that the network device configures the second processing capability; or, enable the first processing capability for data processing by default, in a case that it is determined according to the information that the terminal reports supporting the first processing capability, and it is determined according to the configuration information that the network device does not configures the second processing capability or the second processing capability is set as disabled; or, enable the first processing capability for data processing according to the configuration information, in a case that it is determined according to the information that the terminal reports supporting the first processing capability, and it is determined according to the configuration information that the network device does not configure the second processing capability or the second processing capability is set as disabled; or, enable the third processing capability for data processing by default, in a case that it is determined according to the configuration information that the network device does not configure the first processing capability and the second processing capability or the first processing capability and the second processing capability are set as disabled.

In an implementation, the processing module 2402 is further configured to enable the third processing capability for data channel/signal processing by default, in a case that the terminal reports not supporting the first processing capability and reports not supporting the second processing capability.

In an embodiment of the present disclosure, the eRedCap terminal is a terminal configured to support the first processing capability, the second processing capability and the third processing capability. The second processing capability and the third processing capability are optional capabilities respectively, and the first processing capability is a default capability in a case that the terminal processing capability is not reported.

In an implementation, the processing module 2402 is specifically configured to: enable the first processing capability for data processing by default, in a case that it is determined according to the information that the terminal reports supporting the third processing capability, and it is determined according to the configuration information that the network device does not configure the third processing capability or sets the third processing capability as disabled; or, enable the first processing capability for data processing by default, in a case that it is determined according to the configuration information that the network device does not configure the third processing capability and the second processing capability, or sets the third processing capability and the second processing capability as disabled.

In an implementation, the processing module 2402 is specifically configured to enable any one of the first processing capability, the second processing capability and the third processing capability for data processing, in a case that it is determined according to the information that the terminal reports the second processing capability and the third processing capability simultaneously.

In an implementation, the processing module 2402 is specifically configured to: enable a corresponding processing capability for data processing according to the configuration information, in a case that it is determined according to the information that the terminal does not report the third processing capability, and it is determined according to the information that the terminal reports the second processing capability; or, enable the first processing capability for data processing, in a case that it is determined according to the information that the terminal does not report the third processing capability, and it is determined according to the information that the terminal does not report the second processing capability.

In an implementation, the processing module 2402 is further configured to always enable the third processing capability for data processing by default, in a case that it is determined according to the information that the terminal reports supporting the third processing capability.

In an embodiment of the present disclosure, the configuration information is separately configured for uplink transmission, downlink transmission and channel state information (CSI) calculation; or, the configuration information is combinatively configured for at least two of uplink transmission, downlink transmission and CSI calculation.

In an embodiment of the present disclosure, the eRedCap terminal is a terminal that only supports the third processing capability. In an implementation, the processing module 2402 is further configured to enable the third processing capability for data processing.

The communication apparatus 240 is the network device.

For a scheme that the communication apparatus 240 executes the above method for determining the terminal processing capability, in an embodiment of the present disclosure, the communication apparatus 240 may include a processing module 2402 and a transceiving module 2401. The transceiving module 2401 is configured to receive information sent by a terminal to indicate the terminal processing capability supported by the terminal, and the processing module 2402 is configured to determine the terminal processing capability supported by the terminal according to the information. The terminal is an eRedCap terminal, and the terminal processing capability at least one of a first processing capability, a second processing capability and a third processing capability. The first processing capability is lower than the second processing capability, and the third processing capability is lower than the first processing capability.

In an embodiment of the present disclosure, the eRedCap terminal is a terminal configured to support the first processing capability, the second processing capability and the third processing capability. The first processing capability and the second processing capability are optional capabilities respectively, and the third processing capability is a default capability in a case that the terminal processing capability is not reported.

In an implementation, the transceiving module 2401 is specifically configured to: receive first terminal capability signaling sent by the terminal, and the first terminal capability signaling indicates that the terminal supports the first processing capability and does not support the second processing capability; and the processing module 2402 is specifically configured to determine that the terminal supports the first processing capability and does not support the second processing capability according to the first terminal capability signaling.

In an implementation, the transceiving module 2401 is specifically configured to receive the second terminal capability signaling sent by the terminal, and the second terminal capability signaling indicates that the terminal supports the first processing capability and the second processing capability; and the processing module 2402 is specifically configured to determine that the terminal supports the first processing capability and the second processing capability according to the second terminal capability signaling.

In an implementation, the transceiving module 2401 is specifically configured to receive third terminal capability signaling sent by the terminal, and the third terminal capability signaling indicates that the terminal supports the first processing capability; and the processing module 2402 is specifically configured to determine that the terminal supports the first processing capability according to the third terminal capability signaling.

In an implementation, the transceiving module 2401 is specifically configured to receive a first message sent by the terminal, in which the first message does not report that the terminal supports the first processing capability, and the first message does not report that the terminal supports the second processing capability; and the processing module 2402 is specifically configured to determine that the terminal supports the third processing capability according to the first message.

In an embodiment of the present disclosure, the eRedCap terminal is a terminal configured to support the first processing capability, the second processing capability and the third processing capability. The second processing capability and the third processing capability are optional capabilities respectively, and the first processing capability is a default capability in which the terminal processing capability is not reported.

In an implementation, the transceiving module 2401 is specifically configured to: receive third terminal capability signaling sent by the terminal, and the third terminal capability signaling indicates that the terminal supports the third processing capability and does not support the first processing capability and the second processing capability; and the processing module 2402 is specifically configured to determine that the terminal supports the third processing capability and does not support the first processing capability and the second processing capability according to the third terminal capability signaling.

In an implementation, the transceiving module 2401 is specifically configured to receive a second message sent by the terminal, and the second message does not report that the terminal supports the third processing capability; and the processing module 2402 is specifically configured to determine that the terminal supports the first processing capability and does not support the third processing capability according to the second message.

In an implementation, the transceiving module 2401 is specifically configured to receive second terminal capability signaling sent by the terminal, and the second terminal capability signaling indicates that the terminal supports the second processing capability and does not support the third processing capability; and the processing module 2402 is specifically configured to determine that the terminal supports the second processing capability and does not support the third processing capability according to the second terminal capability signaling.

In an implementation, the transceiving module 2401 is specifically configured to receive third terminal capability signaling sent by the terminal, and the third terminal capability signaling indicates that the terminal supports the third processing capability; and the processing module 2402 is specifically configured to determine that the terminal supports the third processing capability according to the third terminal capability signaling.

In an embodiment of the present disclosure, the eRedCap terminal is a terminal that only supports the third processing capability. In an implementation, the transceiving module 2401 is specifically configured to receive third terminal capability signaling sent by the terminal, and the third terminal capability signaling reports at least one of a bandwidth capability, a data scheduling capability and a terminal type of the terminal; and the processing module 2402 is specifically configured to determine that the terminal only supports the third processing capability according to the third terminal capability signaling.

For a scheme that the communication apparatus 240 executes the above data processing method, in an embodiment of the present disclosure, the communication apparatus 240 may include a processing module 2402 and a transceiving module 2401. The transceiving module 2401 is configured to receive information indicating a terminal processing capability supported by a terminal sent by the terminal; the processing module 2402 is configured to configure a processing capability of the terminal according to the terminal processing capability supported by the terminal; and the transceiving module 2401 is further configured to send configuration information to the terminal, and the configuration information is configured to instruct the terminal to perform data processing based on the processing capability corresponding to the configuration of the network device. The terminal is an eRedCap terminal, and the terminal processing capability includes at least one of a first processing capability, a second processing capability and a third processing capability. The first processing capability is lower than the second processing capability, and the third processing capability is lower than the first processing capability.

In an embodiment of the present disclosure, the eRedCap terminal is a terminal that only supports the third processing capability. In an implementation, the processing module 2402 schedules the terminal based on the third processing capability.

As for the apparatuses in the above embodiments, the specific way in which each module performs the operation has been described in detail in the embodiments of the methods, and will not be described in detail here.

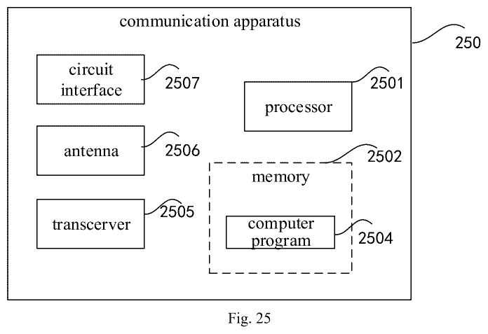

Referring to FIG. 25, FIG. 25 is a schematic diagram of another communication apparatus 250 provided by an embodiment of the present disclosure. The communication apparatus 250 may be a network device, a terminal, a chip, a chip system, or a processor that supports the network device to realize the above methods, or a chip, a chip system, or a processor that supports the terminal to realize the above methods. The apparatus may be used to realize the methods described in the above method embodiments, and for details, reference may be made to the descriptions in the above method embodiments.

The communication apparatus 250 may include one or more processors 2501. The processor 2501 may be a general-purpose processor or a special-purpose processor or the like. For example, a baseband processor or a central processing unit. The baseband processor may be used to process communication protocols and communication data, and the central processor may be used to control communication apparatuses (such as base stations, baseband chips, terminals, terminal chips, DUs or CUS, etc.), execute computer programs, and process data of computer programs.

In some embodiments, the communication apparatus 250 may further include one or more memories 2502, on which a computer program 2504 may be stored, and the processor 2501 executes the computer program 2504, so that the communication apparatus 250 may execute the methods described in the above method embodiments. In some embodiments, data may also be stored in the memory 2502. The communication apparatus 250 and the memory 2502 may be arranged separately or integrated together.

In some embodiments, the communication apparatus 250 may further include a transceiver 2505 and an antenna 2506. The transceiver 2505 may be called a transceiving unit, a transceiving machine, a transceiving circuit, etc., and is used to realize a transceiving function. The transceiver 2505 may include a receiver and a transmitter, the receiver may be called a receiving machine or a receiving circuit, etc., for realizing a receiving function, and the transmitter may be called a transmitting machine or a transmitting circuit, etc., for realizing a transmitting function.

In some embodiments, the communication apparatus 250 may further include one or more interface circuits 2507. The interface circuit 2507 is used to receive code instructions and transmit them to the processor 2501. The processor 2501 executes the code instructions to cause the communication apparatus 250 to perform the methods described in the above method embodiments.

The communication apparatus 250 is a terminal, and the processor 2501 is used to execute step 201 in FIG. 2; step 301 in FIG. 3; step 401 in FIG. 4; step 501 in FIG. 5; step 601 in FIG. 6; step 701 in FIG. 7; step 801 in FIG. 8; step 901 in FIG. 9; step 1001 in FIG. 10; step 1101 in FIG. 11 or step 2203 in FIG. 22. The transceiver 2505 is used to perform step 202 in FIG. 2; step 302 in FIG. 3; step 402 in FIG. 4; step 502 in FIG. 5; step 602 in FIG. 6; step 702 in FIG. 7; step 802 in FIG. 8; step 902 in FIG. 9; step 1002 in FIG. 10; step 1102 in FIG. 11; or steps 2201 and 2202 in FIG. 22.

The communication apparatus 250 is a network device, and the transceiver 2505 is used to execute step 1201 in FIG. 12; step 1301 in FIG. 13; step 1401 in FIG. 14; step 1501 in FIG. 15; step 1601 in FIG. 16; step 1701 in FIG. 17; step 1801 in FIG. 18; step 1901 in FIG. 19; step 2001 in FIG. 20; step 2101 in FIG. 21; or steps 2301 and 2303 in FIG. 23. The processor 2501 is used to execute step 1202 in FIG. 12; step 1302 in FIG. 13; step 1402 in FIG. 14; step 1502 in FIG. 15; step 1602 in FIG. 16; step 1702 in FIG. 17; step 1802 in FIG. 18; step 1902 in FIG. 19; step 2002 in FIG. 20; step 2102 in FIG. 21; or step 2302 in FIG. 23.

In an implementation, the processor 2501 may include a transceiver for realizing receiving and transmitting functions. For example, the transceiver may be a transceiving circuit, or an interface, or an interface circuit. The transceiving circuits, interfaces or interface circuits for realizing the receiving and transmitting functions may be separated or integrated. The transceiving circuit, interface or interface circuit may be used for reading and writing codes/data, or the transceiving circuit, interface or interface circuit may be used for signal transmission or transfer.

In an implementation, the processor 2501 may store a computer program, and the computer program is run on the processor 2501 to cause the communication apparatus 250 to execute the methods described in the above method embodiments. The computer program may be embedded in the processor 2501, in which case, the processor 2501 may be implemented by hardware.

In an implementation, the communication apparatus 250 may include a circuit, and the circuit may realize the functions of transmitting or receiving or communicating in the aforementioned method embodiments. The processor and the transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, and the like. The processor and the transceiver may also be manufactured by various IC process technologies, such as complementary metal oxide semiconductors (CMOS), negative channel metal oxide semiconductors (NMOS), positive channel metal oxide semiconductors (PMOS), bipolar junction transistors (BJT), bipolar CMOS (BiCMOS), silicon germanium (SiGe), gallium arsenide (GaAs), etc.

The communication apparatus described in the above embodiments may be a network device or a terminal, but the scope of the communication apparatus described in the present disclosure is not limited to this, and the structure of the communication apparatus may not be limited by FIG. 25. The communication apparatus may be a stand-alone device or may be part of a large device. For example, the communication apparatus may be:
(1) an independent integrated circuit IC, or a chip, or a chip system or subsystem;
(2) a set with one or more ICs, for example, the IC set may also include storage components for storing data and computer programs;
(3) an ASIC, such as a modem;
(4) a module that may be embedded in another device;
(5) a receiving machine, a terminal, an intelligent terminal, a cellular phone, a wireless device, a handset, a mobile unit, a vehicle-mounted device, a network device, a cloud device, an artificial intelligence device, etc.;
(6) others and so on.

Those skilled in the art may also understand that various illustrative logical blocks and steps listed in the embodiments of the present disclosure may be implemented by electronic hardware, computer software, or a combination of both. Whether this function is realized by hardware or software depends on the specific application and the design requirements of the whole system. Those skilled in the art may use various methods to realize the described functions for each specific application, but this realization should not be understood as beyond the scope of protection of the embodiments of the present disclosure.

An embodiment of the present disclosure also provides a communication system, and the communication system includes a communication apparatus serving as a terminal in the embodiment of FIG. 24 and a communication apparatus serving as a network device in the embodiment of FIG. 24, or the communication system includes a communication apparatus serving as a terminal in the embodiment of FIG. 25 and a communication apparatus serving as a network device in the embodiment of FIG. 25.

The present disclosure also provides a readable storage medium on which instructions are stored, which, when executed by a computer, realize the functions of any of the above method embodiments.

The present disclosure also provides a computer program product which, when executed by a computer, realizes the functions of any of the above method embodiments.

The above embodiments may be realized fully or partially by software, hardware, firmware or any combination thereof. When implemented by software, they may be fully or partially implemented in the form of computer program products. The computer program product includes one or more computer programs. When the computer program is loaded and executed on a computer, the flow or function according to the embodiment of the present disclosure is generated fully or partially. The computer may be a general-purpose computer, a special-purpose computer, a computer network, or other programmable devices. The computer program may be stored in a computer-readable storage medium or transmitted from one computer-readable storage medium to another. For example, the computer program may be transmitted from a website, computer, server or data center to another website, computer or data center in a wired (such as coaxial cables, optical fiber, digital subscriber lines (DSLs)) or wireless (such as infrared, radio, microwave, etc.) manner. The computer-readable storage medium may be any available medium that a computer may access or a data storage device such as a server, a data center and the like that contains one or more available media. The available medium may be a magnetic medium (e.g., a floppy disk, a hard disk, a magnetic tape), an optical medium (e.g., a high-density digital video disc (DVD)), or a semiconductor medium (e.g., a solid state disk (SSD)) and the like.

It may be understood by those skilled in the art that first, second and other numerical numbers involved in the present disclosure are only for the convenience of description, and are not intended to limit the scope of the embodiments of the present disclosure, and also not intended to indicate the order.

The term “at least one” in the present disclosure may also be described as one or more, and the term “a plurality of” may be two, three, four or more, which is not limited in the present disclosure. In the embodiment of the present disclosure, for a technical feature, the technical features in this technical feature are distinguished by “first”, “second”, “third”, “A”, “B”, “C” and “D”. The technical features described by “first”, “second”, “third”, “A”, “B”, “C” and “D” do not have a sequential order or a size order.

The corresponding relationship shown in each table in the present disclosure may be configured or predefined. The values of the information in each table are only examples, and may be configured as other values, which is not limited in the present disclosure. When configuring the corresponding relationship between the information and parameters, it is not necessary to configure all the corresponding relationships indicated in each table. For example, in the table in the present disclosure, the corresponding relationship shown by some rows may not be configured. For another example, appropriate transformation adjustments may be made based on the above table, such as splitting, merging and so on. The names of the parameters indicated by the headings in the above tables may also be other names that may be understood by the communication apparatus, and the values or representations of the parameters may also be other values or representations that may be understood by the communication apparatus. Other data structures may also be used when the above tables are implemented, such as arrays, queues, containers, stacks, linear tables, pointers, linked lists, trees, graphs, structures, classes, heaps, hash tables, etc.

Predefinition in the present disclosure may be understood as definition, definition in advance, storage, pre-storage, pre-negotiation, pre-configuration, curing, or pre-burning.

Those ordinary skilled in the art may realize that the units and algorithm steps of various examples described in connection with the embodiments disclosed herein may be implemented in electronic hardware, or a combination of computer software and electronic hardware. Whether these functions are implemented in hardware or software depends on the specific application and design constraints of the technical scheme. Those skilled may use different methods to implement the described functions for each specific application, but such implementation should not be considered beyond the scope of the present disclosure.

It may be clearly understood by those skilled in the art that for the convenience and conciseness of description, the specific working processes of the systems, apparatuses and units described above may refer to the corresponding processes in the aforementioned method embodiments, and will not be repeated here.

The above description only relates to the specific implementation of the present disclosure, but the protection scope of the present disclosure is not limited to this. Any skilled familiar with the related art may easily think of changes or substitutions within the technical scope disclosed in the present disclosure, which should be included in the protection scope of the present disclosure. Therefore, the scope of protection of the present disclosure should be based on the scope of protection of claims.

1. A method for reporting a terminal processing capability, performed by a terminal, and comprising:
determining the terminal processing capability supported by the terminal; and
sending information indicating the terminal processing capability supported by the terminal to a network device,
wherein the terminal is an enhanced reduced capability (eRedCap) terminal; and the terminal processing capability comprises at least one of a first processing capability, a second processing capability or a third processing capability, wherein the first processing capability is lower than the second processing capability, and the third processing capability is lower than the first processing capability.

2. The method according to claim 1, wherein the eRedCap terminal is a terminal configured to support the first processing capability, the second processing capability and the third processing capability, wherein the first processing capability and the second processing capability are optional capabilities respectively, and the third processing capability is a default capability in a case that the terminal processing capability is not reported.

3. The method according to claim 2, wherein sending the information indicating the terminal processing capability supported by the terminal to the network device comprises at least one of:
sending first terminal capability signaling to the network device, wherein the first terminal capability signaling indicates that the terminal supports the first processing capability and does not support the second processing capability;
sending second terminal capability signaling to the network device, wherein the second terminal capability signaling indicates that the terminal supports the first processing capability and the second processing capability;
sending third terminal capability signaling to the network device, wherein the third terminal capability signaling indicates that the terminal supports the first processing capability; or
sending a first message to the network device, wherein the first message does not report that the terminal supports the first processing capability and the first message does not report that the terminal supports the second processing capability, and the first message implicitly indicates to the network device that the terminal supports the third processing capability.

4.-7. (canceled)

8. The method according to claim 1, wherein the eRedCap terminal is a terminal configured to support the first processing capability, the second processing capability and the third processing capability, wherein the second processing capability and the third processing capability are optional capabilities respectively, and the first processing capability is a default capability in a case that the terminal processing capability is not reported.

9. The method according to claim 8, wherein sending the information indicating the terminal processing capability supported by the terminal to the network device comprises at least one of:
sending third terminal capability signaling to the network device, wherein the third terminal capability signaling indicates that the terminal supports the third processing capability and does not support the first processing capability and the second processing capability;
sending a second message to the network device, wherein the second message does not report that the terminal supports the third processing capability, and the second message implicitly indicates to the network device that the terminal supports the first processing capability and does not support the third processing capability;
sending second terminal capability signaling to the network device, wherein the second terminal capability signaling indicates that the terminal supports the second processing capability and does not support the third processing capability; or
sending third terminal capability signaling to the network device, wherein the third terminal capability signaling indicates that the terminal supports the third processing capability.

10.-13. (canceled)

14. The method according to claim 1, wherein the eRedCap terminal is a terminal that only supports the third processing capability, wherein
sending the information indicating the terminal processing capability supported by the terminal to the network device comprises:
sending third terminal capability signaling to the network device, wherein the third terminal capability signaling reports at least one of a bandwidth capability, a data scheduling capability or a terminal type of the terminal, and implicitly indicates to the network device that the terminal only supports the third processing capability.

15. A method for determining a terminal processing capability, performed by a network device, and comprising:
receiving information indicating the terminal processing capability supported by a terminal sent by the terminal; and
determining the terminal processing capability supported by the terminal according to the information,
wherein the terminal is an eRedCap terminal; and the terminal processing capability comprises at least one of a first processing capability, a second processing capability or a third processing capability, wherein the first processing capability is lower than the second processing capability, and the third processing capability is lower than the first processing capability.

16. The method according to claim 15, wherein the eRedCap terminal is a terminal configured to support the first processing capability, the second processing capability and the third processing capability, wherein the first processing capability and the second processing capability are optional capabilities respectively, and the third processing capability is a default capability in a case that the terminal processing capability is not reported.

17. The method according to claim 16, wherein
receiving the information indicating the terminal processing capability supported by the terminal sent by the terminal comprises at least one of:
receiving first terminal capability signaling sent by the terminal, wherein the first terminal capability signaling indicates that the terminal supports the first processing capability and does not support the second processing capability;
receiving second terminal capability signaling sent by the terminal, wherein the second terminal capability signaling indicates that the terminal supports the first processing capability and the second processing capability;
receiving third terminal capability signaling sent by the terminal, wherein the third terminal capability signaling indicates that the terminal supports the first processing capability; or
receiving a first message sent by the terminal, wherein the first message does not report that the terminal supports the first processing capability and the first message does not report that the terminal supports the second processing capability; and
determining the terminal processing capability supported by the terminal according to the information comprises at least one of:
determining that the terminal supports the first processing capability and does not support the second processing capability according to the first terminal capability signaling;
determining that the terminal supports the first processing capability and the second processing capability according to the second terminal capability signaling;
determining that the terminal supports the first processing capability according to the third terminal capability signaling; or
determining that the terminal supports the third processing capability according to the first message.

18.-20. (canceled)

21. The method according to claim 15, wherein the eRedCap terminal is a terminal configured to support the first processing capability, the second processing capability and the third processing capability, wherein the second processing capability and the third processing capability are optional capabilities respectively, and the first processing capability is a default capability in a case that the terminal processing capability is not reported.

22. The method according to claim 21, wherein
receiving the information indicating the terminal processing capability supported by the terminal sent by the terminal comprises at least one of:
receiving third terminal capability signaling sent by the terminal, wherein the third terminal capability signaling indicates that the terminal supports the third processing capability and does not support the first processing capability and the second processing capability;
receiving a second message sent by the terminal, wherein the second message does not report that the terminal supports the third processing capability;
receiving second terminal capability signaling sent by the terminal, wherein the second terminal capability signaling indicates that the terminal supports the second processing capability and does not support the third processing capability; or
receiving third terminal capability signaling sent by the terminal, wherein the third terminal capability signaling indicates that the terminal supports the third processing capability; and
determining the terminal processing capability supported by the terminal according to the information comprises at least one of:
determining that the terminal supports the third processing capability and does not support the first processing capability and the second processing capability according to the third terminal capability signaling;
determining that the terminal supports the first processing capability and does not support the third processing capability according to the second message;
determining that the terminal supports the second processing capability and does not support the third processing capability according to the second terminal capability signaling; or
determining that the terminal supports the third processing capability according to the third terminal capability signaling.

23.-25. (canceled)

26. The method according to claim 15, wherein the eRedCap terminal is a terminal that only supports the third processing capability, wherein
receiving the information indicating the terminal processing capability supported by the terminal sent by the terminal comprises:
receiving third terminal capability signaling sent by the terminal, wherein the third terminal capability signaling reports at least one of a bandwidth capability, a data scheduling capability or a terminal type of the terminal; and
determining the terminal processing capability supported by the terminal according to the information comprises:
determining that the terminal only supports the third processing capability according to the third terminal capability signaling.

27. A data processing method, performed by a terminal, and comprising:
sending information indicating a terminal processing capability supported by the terminal to a network device;
receiving configuration information configured by the network device for the terminal according to the terminal processing capability supported by the terminal; and
enabling a corresponding processing capability for data processing according to at least one of the information or the configuration information,
wherein the terminal is an eRedCap terminal; and the terminal processing capability comprises at least one of a first processing capability, a second processing capability or a third processing capability, wherein the first processing capability is lower than the second processing capability, and the third processing capability is lower than the first processing capability.

28. The method according to claim 27, wherein the eRedCap terminal is a terminal configured to support the first processing capability, the second processing capability and the third processing capability, wherein the first processing capability and the second processing capability are optional capabilities respectively, and the third processing capability is a default capability in a case that the terminal processing capability is not reported.

29. The method according to claim 28, wherein enabling the corresponding processing capability for data processing according to at least one of the information or the configuration information comprises at least one of:
enabling the first processing capability for data processing by default, or enabling the first processing capability for data processing according to the configuration information, in a case that it is determined according to the information that the terminal reports supporting the second processing capability, and it is determined according to the configuration information that the network device does not configure the second processing capability or sets the second processing capability as disabled;
enabling the first processing capability for data processing by default, or enabling the first processing capability for data processing according to the configuration information, in a case that it is determined according to the information that the terminal does not report supporting the second processing capability, and it is determined according to the information that the terminal reports supporting the first processing capability;
enabling the first processing capability for data processing by default, or enabling the first processing capability for data processing according to the configuration information, in a case that it is determined according to the information that the terminal reports supporting the first processing capability;
enabling the first processing capability for data processing, in a case that it is determined according to the information that the terminal reports supporting the first processing capability, and it is determined according to the configuration information that the network device configures the first processing capability;
enabling the third processing capability for data processing, in a case that it is determined according to the information that the terminal reports supporting the first processing capability, and it is determined according to the configuration information that the network device does not configure the first processing capability or configures the first processing capability as disabled;
enabling the second processing capability for data processing, in a case that it is determined according to the information that the terminal reports supporting the second processing capability, and it is determined according to the configuration information that the network device configures the second processing capability;
enabling the first processing capability for data processing, in a case that it is determined according to the information that the terminal reports supporting the second processing capability, and it is determined according to the configuration information that the network device does not configure the second processing capability or sets the second processing capability as disabled;
enabling the third processing capability for data processing, in a case that it is determined according to the information that the terminal reports supporting the first processing capability, and it is determined according to the configuration information that the network device sets the first processing capability as disabled;
enabling the second processing capability for data processing, in a case that it is determined according to the information that the terminal reports supporting the second processing capability, and it is determined according to the configuration information that the network device configures the second processing capability;
enabling the third processing capability for data processing, in a case that it is determined according to the information that the terminal reports supporting the second processing capability, and it is determined according to the configuration information that the network device does not configure the second processing capability or sets the second processing capability as disabled;
enabling the second processing capability for data processing, in a case that it is determined according to the information that the terminal reports supporting the first processing capability, and it is determined according to the configuration information that the network device configures the second processing capability;
enabling the first processing capability for data processing by default, in a case that it is determined according to the information that the terminal reports supporting the first processing capability, and it is determined according to the configuration information that the network device does not configure the second processing capability or sets the second processing capability as disabled;
enabling the first processing capability for data processing according to the configuration information, in a case that it is determined according to the information that the terminal reports supporting the first processing capability, and it is determined according to the configuration information that the network device does not configure the second processing capability or sets the second processing capability as disabled;
enabling the third processing capability for data processing by default, in a case that it is determined according to the configuration information that the network device does not configure the first processing capability and the second processing capability or sets the first processing capability and the second processing capability as disabled; or
enabling the third processing capability for data channel/signal processing by default, in a case that the terminal reports not supporting the first processing capability and reports not supporting the second processing capability.

30.-36. (canceled)

37. The method according to claim 27, wherein the eRedCap terminal is a terminal configured to support the first processing capability, the second processing capability and the third processing capability, wherein the second processing capability and the third processing capability are optional capabilities respectively, and the first processing capability is a default capability in a case that the terminal processing capability is not reported.

38. The method according to claim 37, wherein enabling the corresponding processing capability for data processing according to at least one of the information or the configuration information comprises at least one of:
enabling the first processing capability for data processing by default, in a case that it is determined according to the information that the terminal reports supporting the third processing capability, and it is determined according to the configuration information that the network device does not configure the third processing capability or sets the third processing capability as disabled;
enabling the first processing capability for data processing by default, in a case that it is determined according to the configuration information that the network device does not configure the third processing capability and the second processing capability, or sets the third processing capability and the second processing capability as disabled;
enabling any one of the first processing capability, the second processing capability and the third processing capability for data processing, in a case that it is determined according to the information that the terminal reports the second processing capability and the third processing capability simultaneously;
enabling the corresponding processing capability for data processing according to the configuration information, in a case that it is determined according to the information that the terminal does not report the third processing capability, and it is determined according to the information that the terminal reports the second processing capability:
enabling the first processing capability for data processing, in a case that it is determined according to the information that the terminal does not report the third processing capability, and it is determined according to the information that the terminal does not report the second processing capability; or
always enabling the third processing capability for data processing by default, in a case that it is determined according to the information that the terminal reports supporting the third processing capability.

39.-42. (canceled)

43. The method according to claim 27, wherein the eRedCap terminal is a terminal that only supports the third processing capability, wherein the method further comprises:
enabling the third processing capability for data processing.

44.-49. (canceled)

50. A communication apparatus, comprising a processor and a memory, wherein a computer program is stored in the memory, and the processor executes the computer program stored in the memory to cause the apparatus to perform the method according to claim 1.

51. A non-transitory computer-readable storage medium for storing instructions which, when executed, cause the method according to claim 1 to be implemented.
